(19) United States
(12) Patent Application Publication
(10) Pub. No.: US 2024/0225039 A1
(43) Pub. Date: Jul. 11, 2024

(54) IMPROVED METHOD FOR PREPARATION OF PROTEIN-ENRICHED PRODUCTS FROM PLANT MATERIAL

(71) Applicant: NapiFeryn BioTech sp. z o.o, Lodz (PL)

(72) Inventors: Piotr Wnukowski, Delft (NL); Magdalena Kozlowska, Lodz (PL); Lukasz Stanczyk, Lodz (PL); Danuta Alina Rachwal, Ozorkow (PL)

(73) Assignee: NapiFeryn BioTech sp. z o.o, Lodz (PL)

(21) Appl. No.: 18/561,309

(22) PCT Filed: May 16, 2022
(86) PCT No.: PCT/EP2022/063205

§ 371 Date: Nov. 16, 2023

(30) Foreign Application Priority Data
May 17, 2021 (NL) 2028223

(51) Int. Cl. A23J 1/14

(52) U.S. Cl. CPC A23J 1/144

(57) ABSTRACT

The present invention relates to a process for preparation of protein-enriched products, such as plant protein isolates or protein-fibre formulations, from plant materials such as oilseeds, as well as to the uses of the products obtainable via said process in human food and/or animal feed. In particular, the presented herein processes advantageously make use of solvents based on low-boiling azeotropic mixtures made of an apolar and lipophilic organic ester having up to 5 carbon atoms, with an alcohol having up to 5 carbon atoms, which solvents not only make the need to use noxious hexane-based solvents obsolete, but also can undergo reutilisation cycles by being easily obtainable and recoverable from spent solvents and/or mother liquors as used in the presented herein processes, and consequently render the disclosed processes extremely energy-efficient, suitable for large-scale industrial production, as well as eco-friendly.

### FIELD OF THE INVENTION

The present invention relates to a process for preparation of protein-enriched products, such as plant protein isolates or protein-fibre formulations, from plant materials such as oilseeds, as well as to the uses of the products obtainable via said process in human food and/or animal feed. In particular, the presented herein processes advantageously make use of solvents based on low-boiling azeotropic mixtures made of an apolar and lipophilic organic ester having up to 5 carbon atoms, with an alcohol having up to 5 carbon atoms, which solvents not only make the need to use noxious hexane-based solvents obsolete, but also can undergo reutilisation cycles by being easily obtainable and recoverable from spent solvents and/or mother liquors as used in the presented herein processes, and consequently render the disclosed processes extremely energy-efficient, suitable for large-scale industrial production, as well as eco-friendly.

### BACKGROUND OF THE INVENTION

There is an urgent need to provide the growing human population with food of adequate nutritional quality that is produced in a way that is not harmful to the environment and that is feasible from an economic and technological point of view.

There is consensus among nutrition experts that human needs for protein intake could be better satisfied by consumption of proteins from plant material rather than from animal origin. However, the inherent problem with proteins originating from plant material is that, in their natural form of occurrence, like in seeds, legumes, fruits and grains, they are usually embedded in complex matrices comprising fibres, polysaccharides, fats, lipids, micronutrients and anti-nutritional factors, like phenolic compounds, phytates, et cetera.

To be applied as ingredients in food or animal feed formulations, these proteins need to be extracted from the source material and isolated in purified form or at least provided in a digestible mixture with dietary plant fibre. Moreover, in many food applications it is important that these proteins retain their native functional properties such as solubility, capability to form stable emulsions with fats and oils, capability to form stable gels, foams, et cetera.

In order to remove the unwanted components that are natively associated with the proteins, different purification and separation techniques are known and currently being employed.

Typically, for oilseeds and soya, part of the fat, oil and lipids present in the plant source material may be extracted from the source material by mechanical means such as extrusion or cold pressing to produce oilseed cakes. Alternatively, said fat, oil and lipids can be extracted by chemical means such as extraction in apolar and lipophilic solvents such as hexane. In processes wherein hexane extraction is employed, steam and high temperatures are typically employed to remove residuals of hexane from the meal in a purposely designed desolventizer/toasting step.

While hexane treatment may be an efficient way of extracting oil from the source material, not only is such treatment highly-energy consuming but may also exert negative impact on the quality of the protein in the meal due to partial and irreversible denaturation of the native protein and loss of its relevant functional properties, such as solubility and/or the ability to form stable emulsions with lipids. In addition to this, hexane is toxic and detrimental to the environment.

To avoid denaturation of proteins, in recent years extraction protocols have been designed where the use of hexane is abandoned altogether and the extraction process of proteins starts with whole-fat seeds or cold-pressed cakes after mechanical expelling of part of the oil. For example, processes are known wherein plant material is subjected to a sequence of steps encompassing a sequential use of aqueous and organic solvents to obtain protein isolates. One of such processes is disclosed e.g. in WO02/060273 that teaches extraction of proteins from a sunflower meal with water and using stirring devices with subsequent precipitation of the soluble protein using ethanol. Another example includes WO2011/057407 that discloses methods for obtaining protein concentrates and isolates from rapeseed/canola and teaches a process wherein ethanol is added to a protein mixture with water and wherein water-soluble proteins are precipitated from solution. A further example is provided by WO2013/013949 where a protein isolation process from an oil cake is disclosed comprising the steps of (a) extraction of proteins with an aqueous solution, (b) concentration, and (c) adding water-miscible organic solvent such as methanol, ethanol and acetone, to obtain a protein precipitate. In that document, the extraction of the proteins is carried out by providing a suspension of a crude vegetable protein source in water and stirring the suspension in a Stirred Tank Reactor (STR) type of device. Then, the isolation of the protein is achieved by drying of the precipitate from the mixture of water and water-miscible solvents.

Notable and highly advantageous processes are disclosed in applications WO2019011904 and WO2020016222 filed by NapiFeryn BioTech Sp. z o.o., Poland, which teach processes wherein native and functional protein or plant protein-fibre product, respectively, are successfully obtained in a hexane-free manner from plant material such as oilseeds, legumes, or lentils. The disclosed methods achieve their goal by an advantageous pre-treatment of the plant material, followed by a method of partial extracting of water-soluble proteins under mild and non-destructive conditions using an aqueous solvent, followed by purification of the solid residue using a novel combination of the so called “Generally recognized as safe” (GRAS) organic solvents wherein the last solvent used in the process comprises at least 90 wt % of an apolar (nonpolar) and lipophilic organic ester having up to 5 carbon atoms, based on the total weight of the third solvent, and wherein said organic ester is at least partially miscible with the first aqueous solvent and fully miscible with the second alcohol-based solvent at room temperature, and wherein the amount of the third solvent is chosen such that the overall liquid phase does not separate into distinct liquid phases.

Although the advantageous processes of WO2019011904 and WO2020016222 successfully address the need for the removal of undesired components without the use of toxic solvents such as hexane, and allow for purification of high-quality plant protein materials thanks to the use of a combination of ethanol and ethyl acetate, one major barrier to their implementation in industrial practice is the high costs of recovery of ethyl acetate in its purified form, i.e. having more than 90% purity.

The major reason of this high cost is the propensity of ethyl acetate and similar esters, to form azeotropic mixtures with alcohols and notably ethanol, which azeotropic mixtures are extremely difficult to separate into pure component fractions. The problem is even more complicated if substantial amounts of water are present in the system, which is practically unavoidable in the case of recovery and isolation processes involving biological material such as plants. The particular three component system: water-ethanol-ethyl acetate exhibits ability to form multiple azeotropes in a shape of homo-azeotropes such as ethanol-ethyl acetate or ethanol water, but also as hetero-azeotropes such as ethyl acetate-water.

### SUMMARY OF THE INVENTION

The present disclosure is based on an unexpected and serendipitous empirical observation made during processing of spent solvents (also known as mother liquors) obtained as part of performing the process as described in WO2019011904 and WO2020016222. Namely, a typical composition of these spent solvents comprises more than a half ethyl acetate (expressed as mass fraction w/w) and substantial and comparable amounts of ethanol and water, in addition to plant-derived material such as indigenous plant oil from oilseed processing such as rapeseed, soy, sunflower, flax, etc. A person skilled in the art, equipped with the knowledge about possible ternary and binary azeotropes, would expect that when this mixture is subjected to distillation or evaporation, the first, low boiling azeotrope to be obtained should be one containing a substantial amount of water. Surprisingly, however, we observed that following the evaporation of spent solvents under reduced pressure between 10 to 50 kPa, a distillate was obtained that was virtually free of water. We speculate that this deviation from the expected behaviour could have potentially been due to the presence of plant-derived components from the processed plant materials, and/or possibly due to the presence of salts such as NaCl, KCl, CaCl₂) etc.

Regardless of the underlying cause, similarly surprising was the observed effect that said recovered practically-water-deprived (i.e. containing less than 10% water) azeotropic mixture was sufficiently low polar and lipophilic to efficiently replace the at least 90% pure apolar and lipophilic organic ester solvent of WO2019011904 or WO2020016222.

As a consequence of these observations, a new surprisingly energy-efficient and easily scalable process was discovered for the purification of protein-containing products, such as protein isolates or protein-fibre mixes derived from legumes, grains and oilseeds, wherein the two major classes of impurities, namely phenolic compounds and lipids, can be successfully removed by a cascade of solvents and solvent mixtures of declining polarity, wherein the first solvent is substantially water (at least 90% w/w), the second solvent contains alcohol, whilst the final and most nonpolar solvent is an azeotropic mixture of an apolar and lipophilic organic ester with the alcohol mixed at a ratio in the range of 8:1 to 1:1, and wherein the water content in the final mixture is chosen such that the overall liquid phase does not separate into distinct liquid phases.

One of the advantages of the discovered process is that a mixture having e.g. ethyl acetate and ethanol at the proportion in the range of 8:1 to 1:1 of ethyl acetate to ethanol, and comprising water content lesser than 10% w/w, can also be relatively easily recovered from the spent solvents that are generated during the process. This further reduces the costs of the process, as well as the resulting therefrom potentially environmentally-harmful waste products, due to the fact that the organic solvents can be recirculated or recovered. The recovery of low in water azeotropic mixture of ethyl acetate with ethanol, thanks to the lower boiling point of such mixture than of the pure solvents alone, can advantageously be performed at a relatively low energy input, for example, by any of the techniques such as falling-film evaporation, wiped film evaporation, vacuum evaporation, distillation, and/or combinations thereof etc.

A further advantage is that the plant protein recovered in the final protein-enriched products as obtained by the disclosed processes exhibit low levels of phenolic/polyphenolic compound and lipid impurities as well as low levels of residual solvents; namely we measured they contain less than 1000 ppm ethanol as per dry weight and less than 100 ppm ethyl acetate as per dry weight. Furthermore, protein isolates and protein-fibre products resulting from the disclosed processed largely retain the protein's native functionalities such as nutritional value, solubility, emulsifying capabilities, gelling property etc., which make these protein-containing products suitable to be used as functional ingredients in foods. These and other advantages are explained further herein.

It is an object of present disclosure to provide a streamlined process for production of nutritionally-valuable plant protein-enriched products', which is not only industrially-suitable but also economically feasible. The presented herein methods meet these objectives by radically simplifying solvent recovery process as compared to previously known methods, while at the same time providing similar high-quality plant protein enriched products, even from challenging plant material containing considerable amounts of oils, fats and/or lipids, such as from oilseeds, legumes and lentils.

In a general aspect, a process is provided for preparation of a plant protein-enriched product (42, 44) from plant material (1), wherein said plant material (1) comprises between 10 and 50 wt % on dry weight basis of proteins, said process comprising the steps of:
a) crushing or comminuting the plant material (1) to produce a solid cake (2);
b) extracting the solid cake (2) with an aqueous first solvent comprising at least 90 wt % of water, based on the total weight of the first solvent, to obtain a mixture of a first solid fraction and a first liquid fraction;
c) separating the first liquid fraction (11) from the first solid fraction (12);
d) adding an alcoholic second solvent comprising at least 50 wt % of an alcohol having 1 to 5 carbon atoms which is miscible with water at room temperature, based on the total weight of the second solvent, wherein
   the adding comprises adding the second solvent to the first solid fraction (12), or wherein
   the adding of the second solvent is preceded by concentrating the first liquid fraction (11) to obtain a first liquid fraction protein concentrate (11b) and wherein the adding comprises adding the second solvent to said concentrate (11b);
e) separating any one of the mixtures obtained by adding the second solvent in step d) into a second liquid fraction (21, 23) and a second solid fraction (22, 24);
f) adding a third solvent to the second solid fraction (22, 24) obtained in step e), said third solvent comprising an azeotropic mixture of between 64 to 90 wt % of an apolar and lipophilic organic ester having up to 5 carbon atoms, and between 10 to 35 wt % of the alcohol having 1 to 5 carbon atoms, based on the total weight of the third solvent, and wherein the organic ester is at least partially miscible with the first solvent and fully miscible with the second solvent at room temperature, and wherein the amount of the third solvent is chosen such that the overall liquid phase does not separate into distinct liquid phases; g) separating the mixture obtained in step f) into a third liquid fraction (31, 33), further referred to as azeotropic spent solvent (31, 33) and a third solid fraction (32, 34);
h) drying the third solid fraction (32, 34) obtained in step g) to obtain the plant protein-enriched product (42, 44).

In a particular aspect, methods are provided that process industrial scale amounts of plant material and allow to obtain beyond-laboratory scale amounts of the final plant protein-enriched products.

In a still further aspect, plant protein-enriched products are provided as obtained or obtainable by the processes as described herein.

Last but not least, also provided are uses of the described herein processes and products in human food and/or animal feed production.

### BRIEF DESCRIPTION OF THE FIGURES

For a better understanding of the nature of present disclosure, reference is made to the following detailed description taken in conjunction with the accompanying figures, in which: FIG. 1 schematically shows a possible embodiment of the disclosed methods, wherein plant material (1) is first mechanically processed (step a) to produce a solid cake (2); the cake (2) is then extracted (step b) under mild and non-destructive conditions using an aqueous solvent (“1^{st} solvent”), followed by fractionation (step c) to a first liquid phase (11) and a first solid phase (12). As both of these phases (11, 12) are sources of valuable plant proteins, they both can further undergo sequential treatment by solvents of decreasing polarity and separation cycles, including an alcoholic solvent (step d; “2^{nd} solvent”) comprising at least 50% of a 1-to-5 carbon alcohol, followed by separation (step e) and treatment of the resulting solid-phase comprising fractions (22, 24) by an azeotropic solvent (step f; “3^{rd} solvent”) comprising an azeotropic mixture of such alcohol with a 1-to-5 carbon apolar lipophilic ester. After another round of separation (step g), the resulting solid-phase-comprising fractions (32, 34) can then be dried (step h) leading to production of high-quality plant protein-enriched products (42, 44), such as plant protein isolates (42) or plant protein and fibre mixtures or powders (44);

FIG. 2 depicts a schematic diagram from FIG. 1, additionally conceptually showing an advantageous embodiment of recirculation and recovery of the azeotropic solvent, wherein the spent azeotropic solvent (spent 3^{rd} solvent 31) from fractionation step g) in the production path of the plant protein isolate (42) is reutilised in fractionation step g) in the production path of the plant protein and fibre product (44), after which (as spent 3^{rd} solvent 33), it can undergo a solvent recovery process (dashed line) in a Solvent Recovery Plant (SRP) unit, for example being an evaporator or a distiller, to later be returned and reused for subsequent production rounds according to embodiments of the disclosed methods. Alternatively, spent azeotropic solvents (31, 33) from both the production paths of the plant protein isolate (42) and the plant protein and fibre product (44) can both be directly sent to an SRP unit for a solvent recovery process (embodiment not shown);

FIG. 3 further depicts an embodiment of the process shown in FIG. 2, wherein, advantageously, also the spent alcoholic solvent (spent 2^{nd} solvent 21) from fractionation step e) in the production path of the plant protein isolate (42), can then be reutilised in alcoholic fractionation step e) in the production path of the plant protein and fibre product (44). Naturally, after this, the spent alcoholic solvent (spent 2^{nd} solvent 23) in the production path of the plant protein and fibre product (44), can also undergo a solvent recovery process in a further SRP unit (embodiment not shown);

FIG. 4 schematically shows a general embodiment in accordance with the embodiment of the method shown in FIG. 1, further conceptually depicting that also the drying step h) may result in generation of substantial further portions of spent azeotropic solvents (spent 3^{rd} solvent 41 and 43);

FIG. 5 schematically shows an embodiment whereby these further portions of spent azeotropic solvents (41, 43) may also be reused, together with or independently of the spent azeotropic solvents (31, 33) from fractionation step g), by undergoing a solvent recovery process in an SRP, such as an evaporator or a distiller, and then by being returned to the processes as disclosed herein for subsequent plant protein-enriched product production rounds. Naturally, this or other embodiments of the spent azeotropic solvent reutilisation and/or recovery schemes can independently be combined with any reutilisation and/or recovery schemes for the spent alcoholic solvent in fractionation step e), such as the one shown in FIG. 3;

FIG. 6 conceptually shows an embodiment of the disclosed methods involving a highly advantageous azeotropic solvent reutilisation and recovery scheme, wherein the spent azeotropic solvent (31) from fractionation step g) and further portions of spent azeotropic solvents (41, 43) from drying step h) obtained in the production path of the plant protein isolate (42), and optionally also from the production path of the plant protein and fibre product (44), can be reutilised in fractionation step g) in the production path of the plant protein and fibre product (44). The thus resulting spent azeotropic solvent (33) can then be directed to an SRP for a solvent recovery process to be later returned and reused for subsequent plant protein-enriched products production cycles according to the disclosed methods.

FIG. 7 shows process scheme for the protein isolate obtained from Soybean.

FIG. 8 shows process scheme for the protein-fibre concentrate obtained from Soybean.

FIG. 9 shows process scheme for the protein isolate obtained from DRC.

FIG. 10 shows process scheme for the protein-fibre concentrate obtained from DRC.

FIG. 11 shows total protein content measured for soy protein isolates.

FIG. 12 shows moisture content measured for soy protein isolates.

FIG. 13 shows ash content measured for soy protein isolates.

FIG. 14 shows fat content measured for soy protein isolates.

FIG. 15 shows total phytate content measured for soy protein isolates.

FIG. 16 shows total protein content measured for DRC protein isolates.

FIG. 17 shows moisture content measured for DRC protein isolates.

FIG. 18 shows fat content measured for DRC protein isolates.

FIG. 19 shows ash content measured for DRC protein isolates.

FIG. 20 shows total phytate content measured for DRC protein isolates.

FIG. 21 shows total phenolics content measured for DRC protein isolates.

FIG. 22 shows dispersibility measured for soy protein isolates.

FIG. 23 shows nitrogen solubility measured for soy protein isolates.

FIG. 24 shows emulsification capacity measured for soy protein isolates.

FIG. 25 shows foaming capacity and stability measured for soy protein isolates.

FIG. 26 shows least gelation concentration measured for soy protein isolates.

FIG. 27 shows dispersibility measured for DRC protein isolates.

FIG. 28 shows nitrogen solubility measured for DRC protein isolates.

FIG. 29 shows emulsification capacity measured for DRC protein isolates.

FIG. 30 shows foaming capacity and stability measured for DRC protein isolates.

FIG. 31 shows least gelation concentration measured for DRC protein isolates.

FIG. 32 shows total protein content measured for soy protein-fibre concentrates.

FIG. 33 shows moisture content measured for soy protein-fibre concentrates.

FIG. 34 shows dietary fibre content measured for soy protein-fibre concentrates.

FIG. 35 shows fat content measured for soy protein-fibre concentrates.

FIG. 36 shows ash content measured for soy protein-fibre concentrates.

FIG. 37 shows total phytate content measured for soy protein-fibre concentrates.

FIG. 38 shows total phenolics content measured for soy protein-fibre concentrates.

FIG. 39 shows total protein content measured for DRC protein-fibre concentrates.

FIG. 40 shows moisture content measured for DRC protein-fibre concentrates.

FIG. 41 shows dietary fibre content measured for DRC protein-fibre concentrates.

FIG. 42 shows fat content measured for DRC protein-fibre concentrates.

FIG. 43 shows ash content measured for DRC protein-fibre concentrates.

FIG. 44 shows total phytate content measured for DRC protein-fibre concentrates.

FIG. 45 shows total phenolics content measured for DRC protein-fibre concentrates.

FIG. 46 shows water and oil absorption capacity measured for soy protein-fibre concentrates.

FIG. 47 shows water and oil absorption capacity measured for DRC protein-fibre concentrates.

### DEFINITIONS AND ABBREVIATIONS

The term ‘azeotropic mixture’ or, simply, ‘azeotrope’ as used herein means a mixture of two or more components which together behave as a single component so that the mixture is totally vaporized or totally condensed at a single temperature, and as the mixture undergoes condensation or vaporization, the latter including e.g. evaporation, or, the concentration of the components in the liquid phase is and remains the same as the concentration of the components in the vapour phase.

The term ‘meal’ as used herein refers to plant material in powder form, such as flour, said plant material virtually devoid of oil and lipids by extraction of these oils and lipids with organic or mineral solvents such as hexane with subsequent removal of said solvents by toasting with water steam. The terms ‘mineral solvent’ as used herein refers to solvents derived from fossil deposits like petroleum or bituminous coal by processes of cracking, refinery and/or rectification. The term ‘plant material’ as used herein has its conventional meaning and refers to material derived from plants, encompassing vegetables, fruits, seeds, legumes and grains. The term ‘raw plant material’ as used herein has its conventional meaning and refers to crude plant material that can be converted by processing according to the disclosed methods into a new and useful product such as protein isolate containing proteins originally present in the crude plant material.

The terms ‘indigenous protein’ and indigenous fibre’ as used herein refer to native protein and native fibre. Consequently, if the final protein-fibre product contains indigenous protein and indigenous fibre, this protein and fibre cannot be distinguished from the native protein and native fibre present in the unprocessed plant material.

The term ‘room temperature’ as used herein is a temperature between 18 and 25° C.

The abbreviation ‘GRAS solvents’ stands for solvents that are ‘Generally Regarded As Safe’ and belong to Class 3 in accordance with: Guidance for Industry, Q3C—Tables and List, U.S.

Department of Health and Human Services, Food and Drug Administration Center for Drug Evaluation and Research (CDER), Center for Biologics Evaluation and Research (CBER), February 2012, ICH, Revision 2. In this respect, cf. e.g. https://www.fda.gov/downloads/drugs/guidances/ucm073395.pdf.

The abbreviation ‘STR’ stands for ‘Stirred Tank Reactor’. The abbreviation ‘ALSEOS’ stands for ‘Aqueous Low Shear Extraction of Oil Seeds’ as disclosed in application WO2019011904. The abbreviations ‘CV’, ‘G’, ‘rpm’, ‘DW’ and ‘NS’ respectively stand for ‘Column Volume’, ‘Gravity’, ‘revolutions per minute’, ‘Dry Weight’ and ‘Nitrogen Solubility’.

### DETAILED DESCRIPTION OF THE INVENTION

The general concept underlying the disclosed herein novel processes can be regarded as a provision of an industrially-advantageous alternative to the processes for producing plant protein isolates (further referred to as “protein isolates”) or plant protein and plant fibre mixtures (further referred to as “protein-fibre products”) as disclosed in applications WO2019011904 and WO2020016222, respectively.

The disclosed herein methods differ from the methods as disclosed in any one of said two applications in adding a solvent comprising or being an azeotropic mixture comprising between 64 to 90 wt % of an apolar and lipophilic organic ester having up to 5 carbon atoms, and between 10 to 35 wt % of an alcohol having 1 to 5 carbon atoms, to the third separation step instead of a practically pure (analytical purity grade) and alcohol-free solution of such apolar and lipophilic organic ester having up to 5 carbon atoms.

Hence, in a first general aspect, a process is provided for preparation of a plant protein-enriched product (42, 44) from plant material (1), wherein said plant material (1) comprises between 10 and 50 wt % on dry weight basis of proteins, said process comprising the steps of:
a) crushing or comminuting the plant material (1) to produce a solid cake (2);
b) extracting the solid cake (2) with an aqueous first solvent comprising at least 90 wt % of water, based on the total weight of the first solvent, to obtain a mixture of a first solid fraction and a first liquid fraction;
c) separating the first liquid fraction (11) from the first solid fraction (12);
d) adding an alcoholic second solvent comprising at least 50 wt % of an alcohol having 1 to 5 carbon atoms which is miscible with water at room temperature, based on the total weight of the second solvent, wherein
   the adding comprises adding the second solvent to the first solid fraction (12), or wherein
   the adding of the second solvent is preceded by concentrating the first liquid fraction (11) to obtain a first liquid fraction protein concentrate (11b) and wherein the adding comprises adding the second solvent to said concentrate (11b);
e) separating any one of the mixtures obtained by adding the second solvent in step d) into a second liquid fraction (21, 23) and a second solid fraction (22, 24);
f) adding a third solvent to the second solid fraction (22, 24) obtained in step e), said third solvent comprising an apolar and lipophilic organic ester having up to 5 carbon atoms, further referred to as “the organic ester”, wherein the organic ester is at least partially miscible with the first solvent and fully miscible with the second solvent at room temperature, and wherein the amount of the third solvent is chosen such that the overall liquid phase does not separate into distinct liquid phases;
g) separating the mixture obtained in step f) into a third liquid fraction (31, 33), further referred to as spent third solvent (31, 33) and a third solid fraction (32, 34);
h) drying the third solid fraction (32, 34) obtained in step g) to obtain the plant protein-enriched product (42, 44),
wherein
the third solvent comprises or is an azeotropic mixture comprising:
   between 64 to 90 wt % of the organic ester, and
   between 10 to 35 wt % of the alcohol having 1 to 5 carbon atoms, and
   less than 10 wt %, preferably less than 5 wt % water,
based on the total weight of the third solvent.

An embodiment of such general method is schematically shown in FIG. 1. As used herein, the a solvent comprising or being an azeotropic mixture comprising between 64 to 90 wt % of the organic ester, and between 10 to 35 wt % of an alcohol having 1 to 5 carbon atom, is further referred to as the “azeotropic mixture of the organic ester and the alcohol”, or, simply, the “azeotropic solvent” or the “third solvent”.

The presently disclosed methods using the azeotropic mixture of the organic ester and the alcohol instead of the high-purity organic ester solution from WO2019011904 or WO2020016222, surprisingly provide plant protein-enriched products of identical or comparable quality, while at the same time having the enormous advantage for up-scaling to an industrial-level production capacity in an economically viable and ecologically-friendly manner.

This is mainly due to the fact that the azeotropic mixtures comprising between 64 to 90 wt % of apolar and lipophilic organic esters having up to 5 carbon atoms, between 10 to 35 wt % of alcohols having 1 to 5 carbon atoms, and less than 10 wt % water (based on the total weight of the mixture), are sufficiently chemically stable to allow for their straightforward recirculation, recovery and/or recycling, by e.g. vaporisation such as evaporation, between subsequent (in batchwise production) or continuous process rounds. In addition, azeotropic mixtures of e.g. ethanol or methanol with either of ethyl acetate or methyl acetate have a lower boiling point than their respective components alone, which further reduces the amount of energy needed for the azeotrope recovery via e.g. vaporisation. Naturally, on industrial scale level, such energy savings can account for substantial reduction of operating costs as well as costs associated with the type and amount of required solvent recovery hardware.

The presently disclosed processes provide high quality plant protein-enriched products, which at least match the quality of such products as obtained by the processes described in WO2019011904 or WO2020016222. However, because of the complicated and costly on a large scale recovery options for the high-purity organic ester solvent, the latter processes are primarily suitable for small scale operations, such as batchwise-production serving research and development purposes.

Conversely, the presented herein new processes using the stable, recyclable, and easily-recoverable azeotropic mixture of the organic ester and the alcohol, can be advantageously employed in large-scale batchwise or even more advantageously in continuous processing of plant material resulting in high output production volumes of the plant protein-enriched products. Because of the advantageous azeotropic solvent-choice, the presented processes can be run as a part of a continuous process deployed at industrial scale to deliver thousands of tons of the plant protein-enriched products per year, possibly operating in a 24/7 regime, typically involving more than 6 000 production hours per year.

Thus, in an advantageous aspect of present disclosure, a process is provided, wherein the amount of the plant protein-enriched product (42, 44) obtained in the process amounts to at least 1 kg, preferably to at least 5 kg, more preferably to at least 10 kg, more preferably to at least 20 kg, most preferably to more than 100 kg per processed batch of solid cake (2) or plant material (1) as fed in a batchwise production process or as produced per hour in a continuous production process.

In another embodiment compatible with the above described aspect, a process is provided, wherein the amount of the solid cake (2) extracted in the process amounts to at least 10 kg, preferably at least 20 kg, more preferably at least 30 kg, more preferably at least 40 kg, more preferably at least 50 kg, more preferably at least 100 kg, more preferably at least 200 kg, even more preferably at least 500 kg, most preferably at least 1000 kg or more per solid cake (2) batch as fed in a batchwise production process or as extracted per hour in a continuous production process.

In a further embodiment compatible with the above described ones, a process is provided, wherein the amount of the plant material (1) crushed or comminuted in the process amounts to at least 10 kg, preferably at least 20 kg, more preferably at least 30 kg, more preferably at least 40 kg, more preferably at least 50 kg, more preferably at least 100 kg, more preferably at least 200 kg, even more preferably at least 500 kg, most preferably at least 1000 kg or more per plant material (1) batch as fed in a batchwise production process or as crushed or comminuted per hour in a continuous production process.

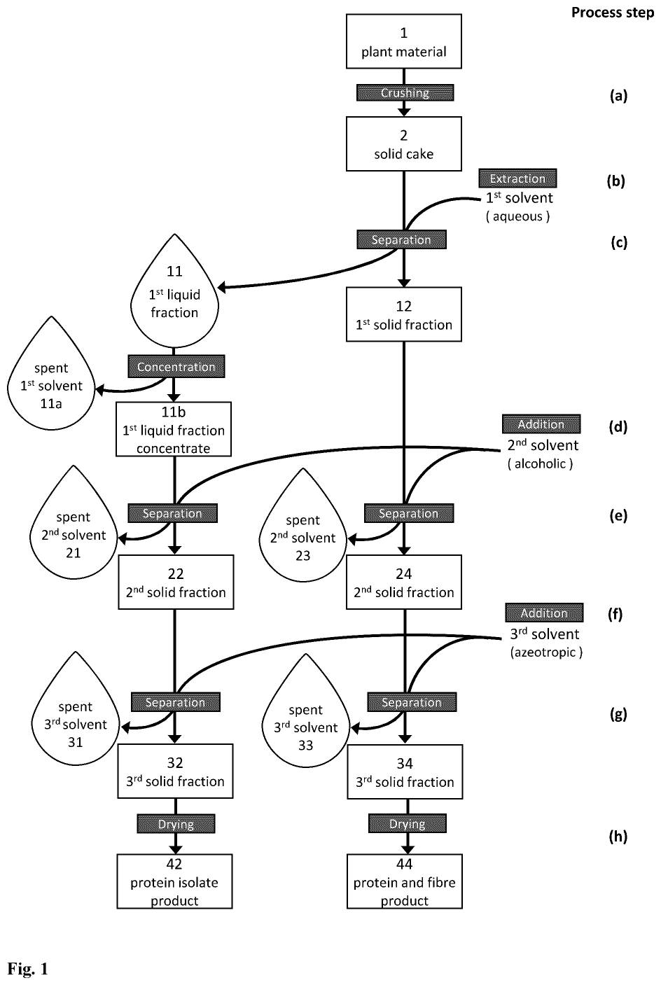

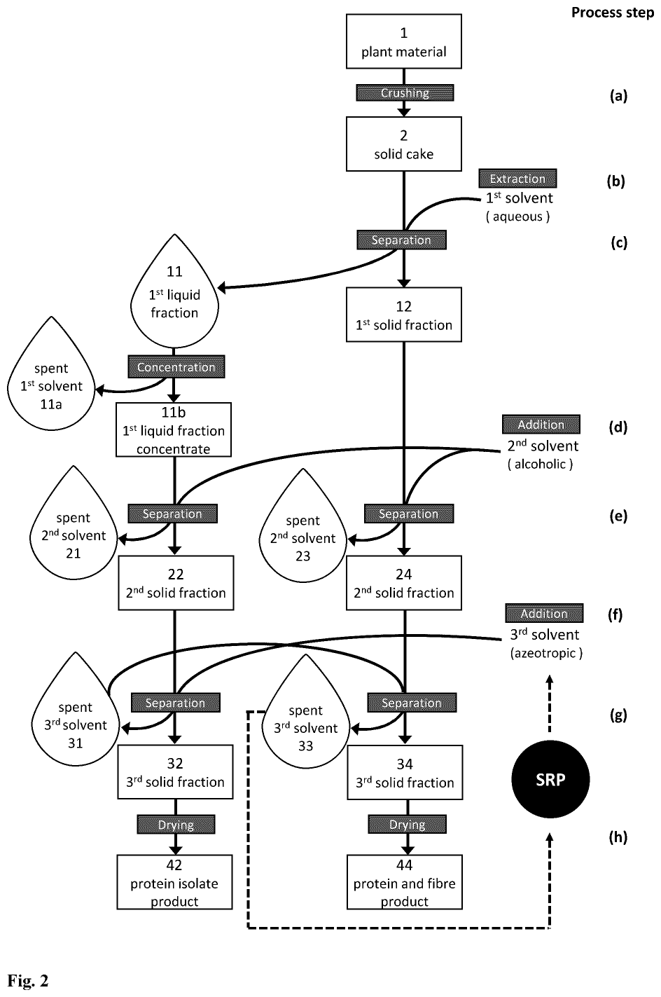

As the ability to recirculate and/or recover the azeotropic solvent has such major impact on the production output upscaling as achievable by the disclosed methods, an advantageous embodiment of the method as schematically presented in FIG. 1 is shown in FIG. 2, further depicting an example of a possible scheme for such azeotropic solvent recirculation and recovery. In this example, the spent azeotropic solvent (31), indicated as “spent 3^{rd} solvent 31”, from fractionation step g) in the production path of the protein isolate (42) is directly reutilised (or recirculated) in fractionation step g) in the production path of the protein-fibre product (44). The direct addition of the spent azeotropic solvent (31) to the separation step g) in the production path of the protein-fibre product (44) is schematically depicted using an arrow drawn with a continuous line.

The direct reutilisation of spent azeotropic solvent in separation step g), or alternatively in any solid fraction washing steps, is possible when, following the preceding utilisation, the spent azeotropic solvent is not too much diluted with water and/or contaminated with plant material-derived compounds, primarily of lipids or fat-type, and on the particular condition that the contents of the spent azeotropic solvent are still comprised between 64 to 90 wt % of the organic ester, and between 10 to 35 wt % of an alcohol having 1 to 5 carbon atoms. If any of these conditions are not met, such spent azeotropic solvent can be sent to a Solvent Recovery Plant (“SRP” in FIG. 2) or an SRP unit to undergo the azeotropic solvent recovery, which comprises removal of water and/or any plant-material-derived contaminants, e.g. using vaporisation.

Such spent azeotropic solvent recovery is schematically shown in FIG. 2 as symbolised by arrows drawn with dashed lines, wherein the spent azeotropic solvent (33), indicated as “spent 3^{rd} solvent 33”, obtained from the separation step g) in the production path of the protein-fibre product (44) is sent to an SRP unit, after which it is returned to the “ready-to-use” azeotropic solvent pool for fresh azeotropic solvent addition as part of step f) of the disclosed processes.

Naturally, the “ready-to-use” azeotropic solvent pool, in addition to the recovered spent solvent, may also be provided with, e.g. filled up, enriched, or even periodically or sporadically refilled or replenished with fresh azeotropic solvent or with solutions of its forming components, such as a substantially pure, high percent and/or laboratory-grade solution of the organic ester of the alcohol having 1 to 5 carbon atoms. The person skilled in art will readily appreciate that this constitutes a common practice, termed “purging”, in the industries where solvents are recovered for further re-using. The practice stems from the fact that in a protein processing plant even in the most efficient solvent recovery processes, some losses of solvents will inevitable happen, for example due to spills, emissions, decomposition etc. To compensate for these losses, fresh, purified solvents may be added to the pool of recovered solvents. Another possible reason for performing a partial replacement of the recovered solvents with fresh or purified solvents, or components thereof, may be the accumulation of unwanted impurities in the recovered solvents. The described herein common purging practices, can naturally be comprised in particular embodiments of the disclosed herein methods.

In addition to the extent of the plant material-derived contaminants, the content of water as carried over in the spent azeotropic solvent is a key determinant whether it can be directly reutilised or recirculated in embodiments of the disclosed processes, or whether it will be directed to an SRP for the azeotropic solvent recovery. For example, plant proteins that ultimately end in the protein-fibre products (44) as obtainable by the present methods, are generally less sensitive to denaturation than certain native proteins present in the protein isolates (42) as also obtainable by the present methods. We estimate that, in certain embodiments of the methods, the former proteins as obtainable in the protein-fibre products (44) can be separated using the azeotropic solvent, possibly being a spent azeotropic solvent, comprising not more than 10 wt % water (based on the total weight of the third solvent), preferably being not more than 7 wt % water, more preferably being not more than 5 wt % water, even more preferably being not more than 2 wt % or even 1 wt % water.

Certain proteins as obtainable according to the present methods in the protein isolates (42), are however best preserved when extracted using apolar lipophilic solvents (cf. D. Fukushima, 1969, Denaturation of soy proteins by organic solvents) and consequently benefit from the addition of the third solvent being an azeotropic mixture comprising between 64 to 90 wt % of the organic ester, between 10 to 35 wt % of an alcohol having 1 to 5 carbon atom, and comprising as little water as possible.

Hence, in a further aspect, a process is provided, wherein the third solvent further comprises less than 7 wt % water, preferably less than 5 wt % water, more preferably less than 2 wt % water, even more preferably less than 1 wt % water, and most preferably less than 0.5 wt % water, expressed as the mass fraction of water in the third solvent.

In further advantageous embodiments of the disclosed processes, the azeotropic mixture comprises between 65 to 85 wt % of the organic ester, preferably between 70 to 84 wt % of the organic ester, more preferably between 75 to 83 wt % of the organic ester, even more preferably between 76 to 82.5 wt % of the organic ester, most preferably between 76.5 to 82.2 wt % of the organic ester, expressed as the mass fraction of the organic ester in the azeotropic mixture.

In advantageous aspects, the organic ester has a relative polarity of less than 0.4. Values of relative polarity for various solvents are disclosed in: Solvents and Solvent Effects in Organic Chemistry, Wiley-VCH Publishers, 3rd ed., 2003. For comparison, water has a relative polarity of 1.

As the disclosed processes ultimately aim at provision plant protein-enriched products for use in human food, and potentially in animal feed, the choice of the organic ester is dictated not only by its functionality but also by health and safety concerns. Due to these constraints, in advantageous embodiments of the disclosed methods, the organic ester forming the azeotropic mixture with the alcohol having 1 to 5 carbon atoms, is ethyl acetate, which is an organic ester commonly used in the food industry and is recognized as a GRAS solvent.

In further examples of the disclosed processes, the azeotropic mixture comprises between 12 to 32 wt % of the alcohol having 1 to 5 carbon atoms, preferably being between 15 to 30 wt %, more preferably between 17 to 27 wt %, even more preferably between 18 to 25 wt %, most preferably between 19 to 22 wt %, and advantageously being about 20 wt % of the alcohol having 1 to 5 carbon atoms, expressed as the mass fraction of the alcohol having 1 to 5 carbon atoms in the azeotropic mixture.

In possible embodiments, the alcohol having 1 to 5 carbon atoms is selected from the group consisting of methanol, ethanol, propanol, iso-propanol, butanol, iso-butanol, or combinations thereof. Advantageously, the alcohol having 1 to 5 carbon atoms has a relative polarity between 0.8 and 0.4.

In view of the same considerations as explained in the context of the selection of suitable organic esters above, primarily driven by health and safety concerns, in advantageous embodiments, the alcohol having 1 to 5 carbon atoms is ethanol, which also is commonly used in the food industry and recognized as a GRAS solvent.

In line with the above, in a further advantageous embodiment of the disclosed processes, the azeotropic mixture comprises ethyl acetate and ethanol, preferably comprises between 64 to 90 wt % of ethyl acetate and between 10 to 35 wt % of ethanol, based on the total weight of the third solvent. In further specific embodiments, the azeotropic mixture may advantageously comprise between 65 to 85 wt %, preferably between 70 to 84 wt %, more preferably between 75 to 83 wt %, even more preferably between 76 to 82.5 wt %, most preferably between 76.5 to 82.2 wt % of ethyl acetate, expressed as the mass fraction of ethyl acetate in the azeotropic mixture, and between 12 to 32 wt %, preferably between 15 to 30 wt %, more preferably between 17 to 27 wt %, even more preferably between 18 to 25 wt %, most preferably between 19 to 22 wt %, and advantageously about 20 wt % of ethanol, expressed as the mass fraction of ethanol in the azeotropic mixture.

The use of azeotropic solvents comprised of ethyl acetate and ethanol being recognized GRAS solvents, to remove residues of fats and lipids from protein-containing plant material, notably including lipid-rich oilseeds, brings the additional advantage of making obsolete the need to use noxious solvents derived from mineral oils, notably including hexane, in the disclosed processes. This also implies elimination of conventional steps that are currently employed by the industry to remove residues of hexane from the meals, said steps typically involving use of steam and high temperatures, which steps significantly limit the extractability and functionality of the proteins present in the meal. Hence, in another aspect, a process is provided, which is performed without using organic or mineral solvents having 6 or more carbon atoms, such as hexane.

Depending on the plant material used and its contents, in an embodiment alternative to the one as shown in FIG. 2 of the azeotropic solvent recovery, the spent azeotropic solvents (31, 33) from both the production paths of the protein isolate (42) and the protein-fibre product (44) can both be directly sent to an SRP unit for a solvent recovery process (embodiment not shown).

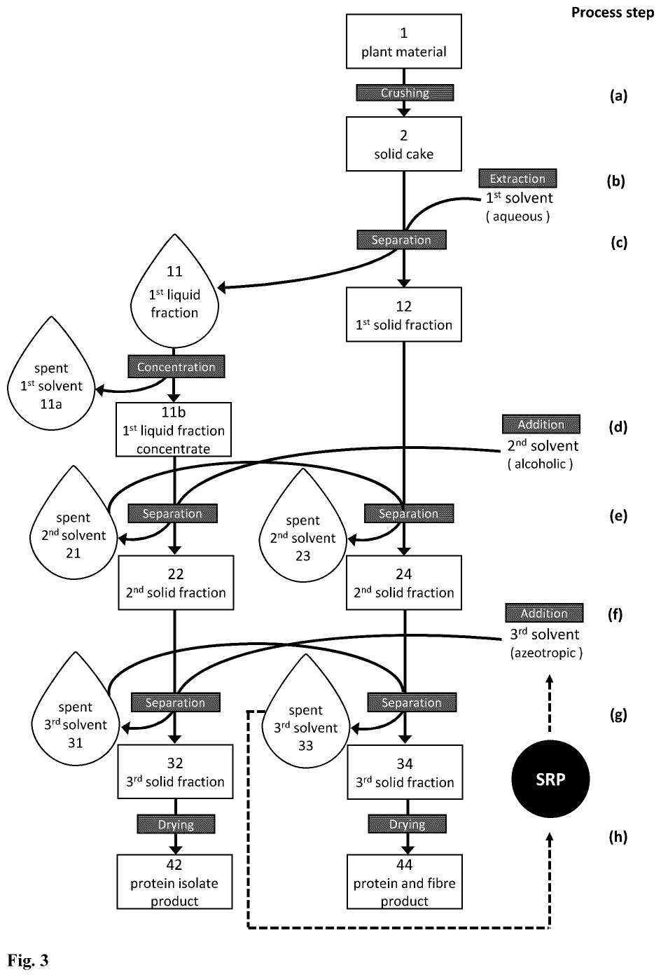

Independently of the selected strategy for the spent azeotropic solvent recirculation and/or recovery in accordance with different embodiments of the disclosed herein methods, said methods may also comprise recirculation and/or recovery for the spent second (or alcoholic) solvents. An example of such is symbolically depicted in FIG. 3, wherein spent alcoholic solvent (spent 2^{nd} solvent 21) from fractionation step e) in the production path of the plant protein isolate (42) is directly added to and thus reutilised in the alcoholic fractionation step e) in the production path of the plant protein and fibre product (44). Naturally, after this, the spent alcoholic solvent (spent 2^{nd} solvent 23) in the production path of the plant protein and fibre product (44), can also undergo a solvent recovery process in a further SRP unit (not shown).

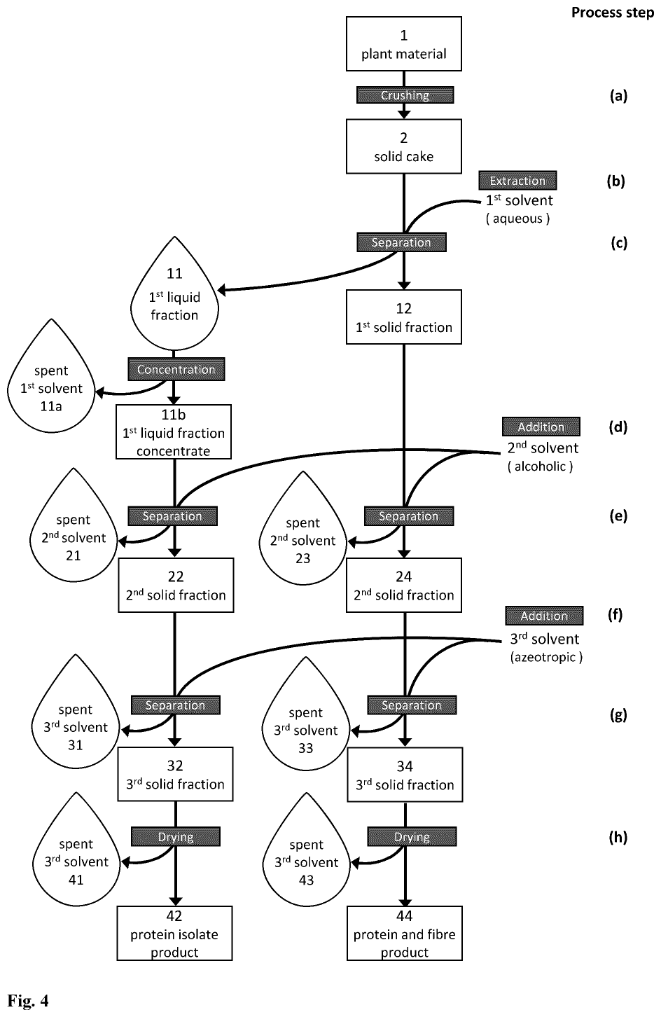

In further possible embodiments of the disclosed processes, substantial amounts of directly reusable, recyclable, and or recoverable spent azeotropic solvent, further referred to herein as “further portions of spent azeotropic solvents” can also be produced as a result of the drying step h), which is schematically shown in FIG. 4 (spent 3^{rd} solvent 41 and 43).

Hence, in a next aspect, processes are hereby disclosed, wherein the drying in step h) of the third solid fraction (32, 34) generates a further portion of a spent third solvent (41, 43), further referred to as a further portion of the spent azeotropic solvent (41, 43).

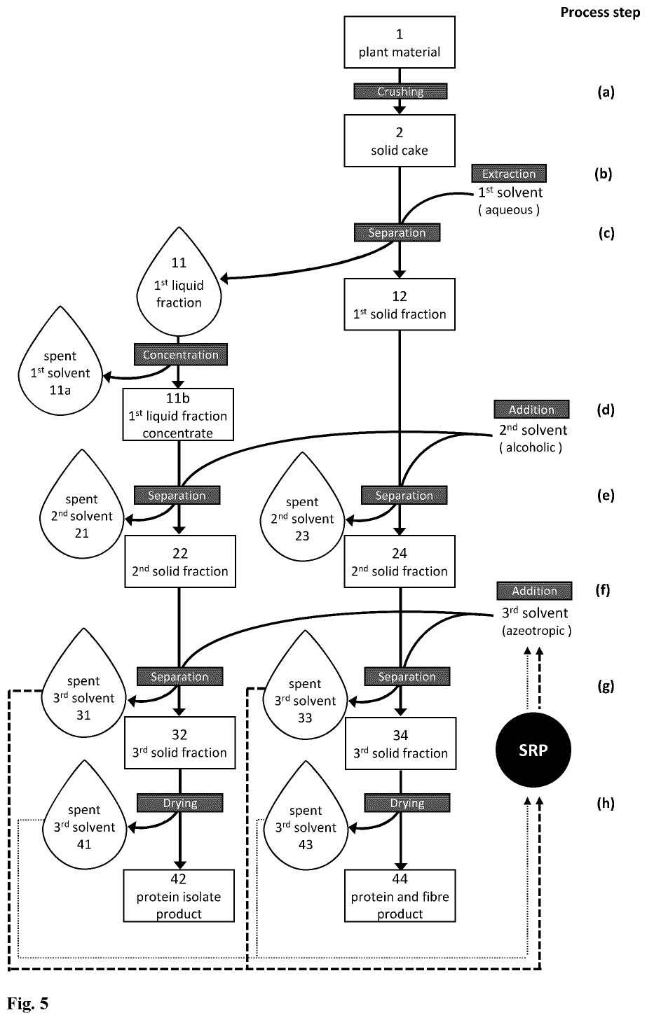

As explained, in advantageous embodiments as schematically shown in FIG. 5, the further portion of the spent azeotropic solvent (41, 43) may also be reused, together with or independently of the spent azeotropic solvents (31, 33) from fractionation step g), by undergoing a solvent recovery process in an SRP, such as an evaporator or a distiller. After this, the thus recovered azeotropic solvent can be returned to the “ready-to-use” azeotropic solvent pool for fresh azeotropic solvent addition as part of step f) in subsequent plant protein-enriched product production rounds according to the disclosed processes.

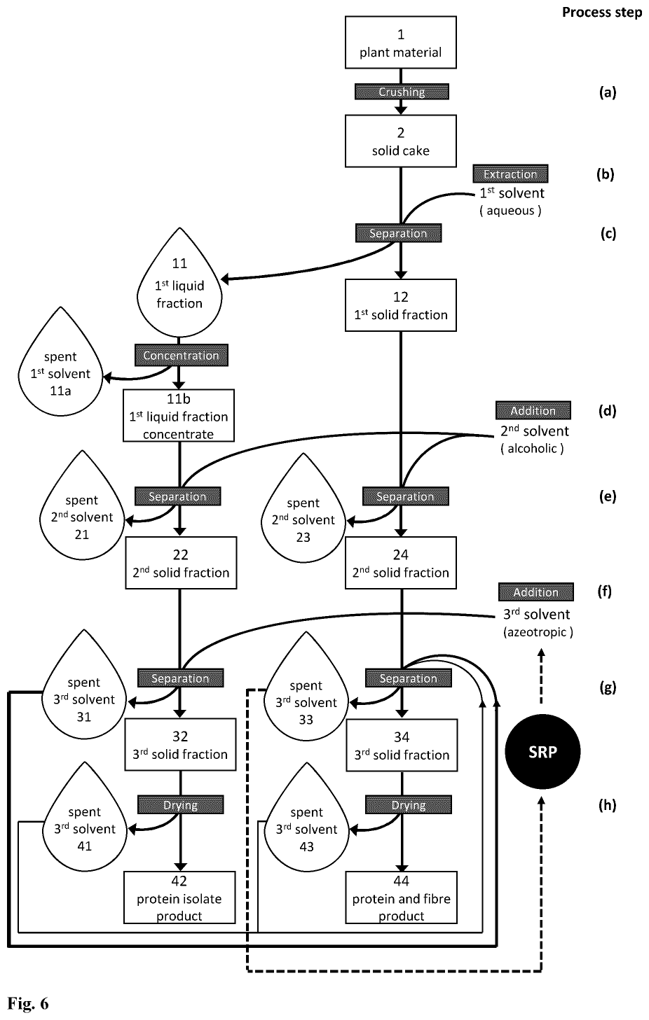

An alternative and particularly advantageous azeotropic solvent reutilisation and recovery scheme, wherein the SRP is less heavily loaded than in the embodiment of FIG. 5, is schematically shown in FIG. 6. In this schematic embodiment, the spent azeotropic solvent (31) from fractionation step g) and the further portions of spent azeotropic solvents (41, 43) from drying step h) obtained in the production path of the plant protein isolate (42), and optionally also from the production path of the plant protein and fibre product (44), are reutilised in fractionation step g) in the production path of the plant protein and fibre product (44). The thus resulting spent azeotropic solvent (33) can then be directed to an SRP for a solvent recovery process to be later returned and reused for subsequent plant protein-enriched products production cycles according to the disclosed methods.

Accordingly, in a further aspect, a process is provided, wherein at least a part of the third solvent added in step f) is recovered from any one of the following: the spent third solvent (31, 33), the further portion of the spent third solvent (41, 43), or a combination thereof.

In a preferred embodiment of the above aspect, a process is provided wherein the any one of the following: the spent third solvent (31, 33), the further portion of the spent third solvent (41, 43), or the combination thereof, from which the part of the third solvent added in step f) is recovered, comprises at least 5 wt % water, preferably at least 10 wt % water, possibly at least 15 wt %, at least 20 wt %, at least 25 wt %, or at least 30 wt % or more water, expressed as the mass fraction of water in the spent third solvents or combinations thereof (31, 33, 41, 43).

In a particular embodiment of the two directly preceding embodiments, a process is provided, wherein the third solvent added in step f) is primarily or entirely recovered from any one of the following: the spent third solvent (31, 33), the further portion of the spent third solvent (41, 43), or a combination thereof. Analogously, in a possible particular embodiment of the latter, a process is also provided wherein the any one of the following: the spent third solvent (31, 33), the further portion of the spent third solvent (41, 43), or the a combination thereof, from the third solvent added in step f) is primarily or entirely recovered, comprises at least 5 wt % water, preferably at least 10 wt % water, possibly at least 15 wt %, at least 20 wt %, at least 25 wt %, or at least 30 wt % or more water, expressed as the mass fraction of water in the spent third solvents or combinations thereof (31, 33, 41, 43).

With regard to the azeotropic solvent recovery, in a further advantageous aspect a process is provided, wherein the recovering of the third solvent comprises application of an operating pressure being equal or lower than 200 kPa, more preferably equal or lower than the atmospheric pressure (1 atm corresponding to 101.325 kPa), preferably wherein the operating pressure is comprised between 20-50 kPa (0.2-0.5 bar).

In a further advantageous aspect, a process is provided, wherein the recovering of the third solvent comprises an evaporation step comprising the use of or performed with an evaporator, preferably chosen from the group comprising rotary evaporators, wiped-film evaporators, scraped-film evaporators, falling-film evaporators, rising-film evaporators, short-path evaporators, preferably being a falling-film evaporator. In another advantageous aspect, a process may be provided, wherein the recovering of the third solvent comprises mechanical vapour recompression.

Naturally, any of the above or other embodiments of the spent azeotropic solvent reutilisation and/or recovery schemes can independently be combined with any reutilisation and/or recovery schemes for the spent alcoholic solvent in fractionation step e), such as the one shown in FIG. 3.

As explained and shown in the above schematic examples, in advantageous embodiments, spent solvents, spent azeotropic solvents in particular, as generated in the disclosed herein processes for the production of protein isolates (42), may advantageously be recirculated or reutilised as solvents, or alternatively as wash solutions, in the disclosed herein processes for the production of plant protein-fibre products (44).

This is because the plant proteins that are retained with indigenous plant fibre in the first solid fraction (12) as obtained following the mild aqueous extraction step b) and separation step c), do not always require such pure solvents as a substantial part of the native water-soluble plant proteins as retained, following said steps, in the first liquid fraction (11). In particular, substantial part of the native water-soluble plant proteins are susceptible to becoming damaged or denatured, possibly by shear stresses resulting from phase separation, which may happen in multi-solvent systems of the disclosed herein methods if an acceptable water limit is exceeded in the given systems.

Because of this, in an advantageous embodiment, the composition of the alcoholic (or second) solvent as added in step d) and/or the composition of the azeotropic (or third) solvent as added in step f) of the disclosed methods, will preferably comprise lower amounts of water in the protein isolate (42) production path, as compared to the corresponding solvents in the protein-fibre product (44) production path.

Consequently, in advantageous embodiments, processes are provided wherein the alcoholic (or second) solvent as added in step d) in the protein isolate (42) production path comprises less than 7 wt % water, preferably less than 5 wt % water, more preferably less than 3 or 2 wt % water, expressed as the mass fraction of water in the second solvent, and/or wherein the azeotropic (or third) solvent as added in step f) in the protein isolate (42) production path comprises less than 2 wt % water, preferably less than 1 wt % water, and most preferably less than 0.5 wt % water, expressed as the mass fraction of water in the third solvent.

In a possible embodiment, a process is provided, wherein the protein-enriched product as obtained by the disclosed processes is a protein-fibre product (44).

In an alternative embodiment, a process is provided, wherein the protein-enriched product as obtained by the disclosed processes is a protein isolate (42).

In an advantageous embodiment in accordance with the two above embodiments, a process is provided, wherein both a protein-fibre product (44) and a protein isolate (42) are obtained as protein-enriched products.

In a particular embodiment of the provided method, the adding in step d) comprises adding the second solvent to the first solid fraction (12) and the plant protein-enriched product (42, 44) obtained in step h) is a protein-fibre product (44) comprising plant protein and indigenous fibre, preferably wherein the total content of the plant protein and indigenous fibre is at least 30 wt %, based on total dry weight of the protein-fibre product (44).

Further advantageous embodiments applicable to the above embodiment can be found in WO2020016222, which is hereby incorporated by reference. For example, in an advantageous embodiment, the second solvent comprises at least 60 wt %, preferably at least 70 wt %, more preferably at least 80 wt %, most preferably at least 90 wt % of a alcohol having 1 to 5 carbon atoms which is miscible with water at room temperature, based on the total weight of the second solvent.

In another particular embodiment, a process is provided, wherein the plant protein-enriched product (42, 44) obtained in step h) is a protein isolate (42) wherein the protein content is at least 90 wt %, preferably at least 95 wt %, based on total dry weight of the a protein isolate; and wherein
the adding in step d) is preceded by concentrating the first liquid fraction (11) to obtain a first liquid fraction protein concentrate (11b), said concentrate (11b) preferably comprising between 50 to 90 wt % of water based on the total weight of said concentrate (11b) and at least 40 wt % protein content based on total dry weight of said concentrate (11b), and wherein the adding comprises adding the second solvent comprising at least 90 wt % of the alcohol to said concentrate (11b); and
wherein the third solvent added in step f) preferably comprises less than 2 wt % water, more preferably less than 1 wt % water, and most preferably less than 0.5 wt % water, and preferably also wherein
the protein content of the second solid fraction (22) obtained in step e) is at least 60 wt %, based on total dry weight of the second solid fraction (22); and/or
the protein content of the third solid fraction (32) obtained in step g) is at least 90 wt %, based on total dry weight of the third solid fraction (32).

In an advantageous embodiment of the presented methods, wherein the plant protein-enriched product obtained in step h) is a protein isolate (42), and depending on the plant material (1) used, a process may be provided wherein in the step d) the first liquid fraction (11) is further subjected to one or more diafiltration steps to remove at least part of the non-protein components and/or wherein the first liquid fraction (11) may be subjected to an evaporation step.

As explained in WO2019011904, which is hereby incorporated by reference, after separation from first solid fraction (12), the first liquid fraction (11) obtained for the production of the protein isolate (42), may optionally be subjected to another solid-liquid separation step using e.g. filtration devices like self-cleaning filters or depth filters or the first liquid fraction may be subjected to centrifugation in disc-stack centrifuges or similar devices, with the aim of removing solid fines and/or lipids that may be present in the first liquid phase.

In a possible embodiment, the concentrating of the first liquid fraction (11) to obtain a first liquid fraction protein concentrate (11b) and discard the aqueous 1^{st} solvent (11a), preferably comprises ultrafiltration, evaporation or a combination thereof. In one embodiment, the first liquid fraction (11) may be subjected in to ultrafiltration in a TFF device with a filtration membrane of the hollow fibre type, a ceramic membrane or a spiral-wound membrane, said filtration membrane having an opening size (cut off size) small enough to retain proteinaceous matter of typically 6-20 kD present in the first liquid phase, while being permeable to other solutes like peptides, polysaccharides, oligosaccharides, sugars, phenolic compounds, phytates and salts being present in the first liquid fraction. Possibly, after the ultrafiltration concentration step, preferably a diafiltration step of the ultrafiltration retentate with fresh water or with an aqueous solution comprising salts is optionally employed comprising further additives to produce a the first liquid fraction concentrate (11b) comprising at least 10 wt % solids either dissolved or precipitated, wherein the protein content in such first liquid fraction concentrate (11b) is at least 40 wt %, preferably at least 50 wt %, based on total dry weight of the concentrate, and wherein the protein concentrate comprises 50 to 90 wt % of water, based on the total weight of the protein concentrate. Optionally, the first liquid fraction concentrate (11b) may be subjected to evaporation under vacuum in order to remove an excess of water (11a). As explained in WO2019011904, the skilled person will know several different suitable concentration techniques, including filtration, sedimentation, centrifugation, etc, may be applied to different fractions or parts of the first liquid fraction (11), and their resulting concentrated products may afterwards be pooled to form the final protein-enriched first liquid fraction concentrate (11b) that may be further processed in accordance with the presented herein methods to produce the protein isolate (42).

In an advantageous embodiment of the above embodiment, the protein isolate (42) comprises at least 70 wt % of native plant-based protein based on dry matter, and preferably comprises less than 1 wt % carbohydrates, and/or less than 0.2 wt % phenolic compounds and/or no organic solvents or mineral solvents having 6 or more carbon atoms.

In an advantageous embodiment, the residual amount of the azeotropic solvent in the protein-enriched products (42, 44) as obtained by the disclosed processes in step h), being either a protein-fibre product (44) or a protein isolate (42), is below the acceptable level required by food authorities, typically below 1000 ppm, preferably below 100 ppm, even more preferably below 30 ppm.

Various aspects of possible embodiments of the disclosed methods may depend of the choice of the plant material (1) used, in particular its content of fat and lipids, and or fibre. The plant material (1) is preferably selected from the group consisting of vegetables, fruits, seeds, legumes, grains and combinations thereof. In a possible embodiment, the plant material (1) is raw plant material, which means that it is crude, unprocessed plant material. Examples of plant material (1) include oilseeds, including rapeseed, canola, sunflower, safflower, or cottonseed. Alternative examples include pulses, such as soybeans and other beans, legumes and peas, including chickpea, red, green, yellow and brown lentils, etc. In an advantageous embodiment, the plant material (1) is selected from the group consisting of oilseeds including rapeseed, canola, sunflower seed, flaxseed, safflower seed, cottonseed, and combinations thereof, wherein the plant material preferably is rapeseed, soybean, or sunflower.

Raw plant materials such as oilseeds like rapeseed, canola, sunflower, safflower, cottonseed, etc., pulses such as soybeans and other beans, legumes and peas such as chickpea, red, green, yellow and brown lentils, et cetera, share the common feature that a significant fraction of their native protein content belongs to the protein class called albumins and/or globulins, i.e. they are soluble in water and/or aqueous solutions of inorganic salts containing cations like NH⁴⁺, Li⁺, Na⁺, K⁺, Mg²⁺, Ca²⁺ and/or anions like Cl⁻, SO₄²⁻, SO₃²⁻, HSO₃⁻, et cetera. Besides proteins, these raw plant materials typically also contain other types of compounds which are present in varying proportions depending on the type of plant material. Said other compounds typically are saccharides (poly-, oligo-, mono-), starch, phytates, phenolic compounds, fibrous components, non-protein nitrogen compounds, et cetera. One notable and distinct class of ingredients that may be present in the raw plant materials encompasses lipids such as fats, oils, phospholipids, glycolipids, et cetera, characterized by the common feature of having a non-polar part in their molecular structure composed of fatty acids having a number of carbon atoms within a range from 4 to 28.

The person skilled in art will understand that prior to processing according to the present teachings, raw plant material in the form of whole seeds, beans or grains may be subjected to preselection and/or dry fractionation like dehulling (i.e. removal of pods and outer coats of seeds). Such an operation may be particularly advantageous in case the protein content in the parts that can be removed by dry fractionation is significantly lower than the protein content in the parts that will be subjected to further processing with the aim of obtaining protein products.

Hence, in an embodiment, processes may be provided, wherein, e.g. if the raw plant material comprises whole seeds, beans or grains, the plant material prior to step a) is at least partially depleted of protein-lean and lignin-rich outer layer having a form of coat, bark, husk, hull etcetera, preferably using suitable method of dehulling, decortication, dry fractionation or a combination thereof.

Typically, for oilseeds and soya, part of the fat, oil and lipids present in the raw plant material may be extracted from the raw plant material by mechanical means such as extrusion or cold pressing to produce oilseed cakes, or said fat, oil and lipids can be extracted by chemical means such as extraction in apolar and lipophilic solvents such as hexane. In conventional processes wherein hexane extraction is employed, steam and high temperatures are typically employed to remove residuals of hexane from the meal in a purposely designed desolventizer/toasting step. Such a treatment may have a negative impact on the quality of protein in the meal due to partial and irreversible denaturation of the protein present in the meal and loss of relevant functional properties, such as solubility and/or the ability to form stable emulsions with lipids.

In view of the above, in a possible embodiment, the plant material is at least partially defatted prior to step a) using mechanical means, preferably using cold pressing. Preferably, neither organic nor mineral solvents are used in the defatting step using mechanical means. Also preferably, the raw plant material is not heated to temperatures higher than 75° C.

The advantages of the disclosed process are particularly prominent if the raw plant material contains considerable amounts of fats, oils and/or lipids. Hence, in an embodiment, the raw plant material comprises at least 5 wt %, more preferably at least 10 wt %, even more preferably at least 15 wt %, on dry weight basis of fats, oils and lipids.

As indicated, crushing or comminuting of the raw plant material is performed in step a) of the disclosed methods. This step facilitates the distribution and suspension of the plant material in the first aqueous solvent used for extraction. By doing so, the conditions for effective mass transfer between crushed or comminuted raw plant material (aka the solid cake 2) and the first solvent used for extraction are facilitated.

In an embodiment, the first solvent in step b) is water or an aqueous solution comprising salts such as NaCl, KCl, CaCl₂) and optionally comprising further additives.

Extracting water-soluble components from the crushed or comminuted raw plant material to the first solvent may be accomplished by any technique suitable for facilitating mass transfer between the suspended or dispersed solid phase and the continuous liquid phase of the first solvent such as: i) mixing in a STR;
ii) contacting the crushed or comminuted raw plant material, being immobilized as a packed bed, with a first solvent percolating through the packed bed;
iii) contacting the crushed or comminuted raw plant material by suspending it in an upward flowing first solvent; or
iv) contacting the crushed or comminuted raw plant material with the first solvent by allowing the material to settle in the first solvent due to the action of forces of gravity and/or centrifugal forces.

The person skilled in the art appreciates that all these means and mechanisms of contacting crushed or comminuted raw plant material with the first solvent can be divided into two distinct classes characterized by the amount of shear that is generated in the contacting device. In the low shear mode of operation, like in a packed bed, an expanded bed or a fluidized bed, or during gravitational settling, shear forces and velocity gradients in the contacting devices are on such a low level that the integrity of the crushed or comminuted raw plant material is substantially preserved and mass transfer between crushed or comminuted raw plant material and first solvent is governed mainly by diffusion of soluble components from the crushed or comminuted raw plant material into the stagnant or gently flowing first solvent, while nonsoluble components like fibres and lipids are mainly left intact and are arrested in the solid matrix. In contrast, when a high shear mode of operation is employed, like in an STR, where shear rates due to agitation may well exceed 100 1/s, especially in the vicinity of the agitator, integrity of the crushed or comminuted raw plant material will generally not be preserved, due to disruptive effects of velocity gradients and or turbulence generated by the stirring device. In effect, particles of the crushed or comminuted raw plant material may become subjected to fragmentation with subsequent release of the constituent components like fines and lipids into the liquid phase. Release of these fines and lipids may have negative impact on the process further downstream of the extraction step. Coextraction of proteins and lipids in the high-shear devices may also lead to formation of micro-emulsions wherein proteins, lipids, solid fines and anti-nutritional factors will become entrapped in grease-like amorphous bodies, posing severe problems for the processor and making the process of fractionation, purification and isolation of protein unfeasible. Hence, in a further embodiment, the extraction of water-soluble components in step b) is performed under low-shear conditions.

In an possible embodiment, a method is provided wherein between steps b) and c), at least part of the fats, oils and lipids present in the mixture of the first solid fraction and the first liquid fraction obtained in step b) is removed, preferably using centrifugation, filtration or a combination thereof. In a further advantageous embodiment, the separation of the first liquid fraction (11) from the first solid fraction (12) in step c) is performed using a technique chosen from centrifugation, sedimentation, filtration and/or combinations thereof.

Addition of the second solvent in step d) to the first liquid fraction concentrate (11b) or the first solid fraction (11) will have an effect on the polarity of the liquid phase and may alter the solubility of the proteins, thereby inducing precipitation of the protein, and/or may also alter the nature of interactions between proteins or protein-fibre matrix, respectively, and other components and impurities such as saccharides, phenolic compounds and/or isoflavones in such a way that these impurities can dissociate from the proteins or protein-fibre matrix, respectively, and can be removed from the protein isolates or protein-fibre matrix, respectively, in subsequent solid-liquid separation steps. Thus, the addition of the second solvent in step d) and the replacement of the first solvent may facilitate efficient isolation and/or purification from impurities otherwise associated therewith, which impurities are not amenable to removal while the proteins or the protein-fibre matrix, respectively, are in the first (aqueous) solvent.

The amount of the second solvent used in step d) of the process will be dictated by the degree of concentration of the protein in the first solvent, the solubility of the protein in the mixture of the first solvent and the second solvent and by denaturation effects related to the second solvent. In an embodiment, the amount of the alcoholic second solvent will be such as to reach a weight ratio of the first solvent used in step b) to the second solvent used in step d) is between 1:10 and 1:1, preferably between 1:3 and 2:3.

After the addition of the alcoholic second solvent in step d), a mixture is created wherein protein or protein-fibre is mainly present as a precipitated second solid fraction (22, 24, respectively) and wherein soluble compounds such as saccharides, phenolic compounds, isoflavones and other impurities are found in the liquid phase being the spent alcoholic second solvent (21, 23). Fats and lipids, if present, will be mainly associated with the solid fractions (22, 24).

The solid fractions (22, 24) can then be isolated in step e) from the mixture using a technique chosen from the group consisting of filtration, sedimentation, centrifugation and combinations thereof, to obtain a second solid fraction and a second liquid fraction. As will be appreciated by the skilled person, the second solid fractions (22, 24) comprise traces of solvents used in the process such as water and the water-miscible alcohol. The second solid fraction may also contain residues of fats and lipids that were not removed in other steps of the process.

The person skilled in art will further understand that after isolation of the second solid fraction (22, 24), in order to further improve purity of the protein product, additional washing steps can be employed, whereby fresh portions of the alcoholic second solvent can be added to the second solid fraction (22, 24), followed by suitable solid-liquid separation steps chosen from the group consisting of filtration, sedimentation, centrifugation and combinations thereof. Hence, in a possible embodiment, a process is provided, wherein the second solid fraction (22, 24) after step e) and before step f) is subjected to an additional washing step using alcoholic second solvent followed by a solid-liquid separation step.

The solid-liquid mixture obtained in step f) is then preferably separated in step g) into a third liquid fraction comprising spent azeotropic solvents (31, 33), and the third solid fractions (32, 34) using filtration, sedimentation or centrifugation. Thus, in a regular embodiment, methods may be provided wherein the separating in either step e) or g) comprises a technique chosen from the group consisting of filtration, sedimentation, centrifugation and combinations thereof.

Due to the removal of lipids and other apolar impurities by the action of the disclosed herein azeotropic third solvent, the purity of the protein or the protein-fibre matrix is further improved. The person skilled in the art will also understand that after isolation of the third solid fractions (32, 34), in order to further improve purity and or to further remove residues of the first and second solvents, additional washing steps can be employed, whereby fresh portions of the azeotropic third solvent can be added to the third solid fraction (32, 34), followed by suitable solid-liquid separation steps chosen from the group consisting of filtration, sedimentation, centrifugation and combinations thereof. Hence, in a possible embodiment, a process is provided, wherein the third solid fraction (32, 34) after step g) and before step h) is subjected to an additional washing step using the azeotropic third solvent followed by a solid-liquid separation step. Naturally, in line with general advantageous principles of the disclosure as discussed above, in advantageous possible embodiments, the azeotropic solvent as spent in any one of the washing steps can also be directly reutilised or recycled or, alternatively sent to an SRP for the azeotropic solvent recovery.

Lastly, the third solid fraction (32, 34), which is either the undried protein isolate or the undried protein-fibre product, respectively, which are still moist and/or soaked in the azeotropic third solvent, will be subjected to a drying step h), preferably by a technique chosen from vacuum drying, contact drying, convective drying, spray drying, superheated steam drying, and/or combinations thereof. After the drying step h), the final plant protein-enriched products are obtained, wherein, advantageously, the protein content is exceeds 90 wt % for the protein isolate (42) and protein-indigenous fibre content exceeds 30 wt % for the protein-fibre product (44), based on total dry weight of the fourth solid fraction.

Notably, the disclosed herein processes do not require the use of extreme conditions such as high temperatures or major shifts of the pH. Rather to the contrary, temperatures to which the proteins are exposed throughout the disclosed process are preferably kept in the range between 0 to 70° C., more preferably between 0 to 55° C., more preferably between 4 to 50° C., more preferably between 4 to 20° C., most preferably between 10 to 20° C., while the pH is preferably kept in the range between 4 and 8, although washing steps at different pH values may also possibly be included, since inclusion of additional washing step at high, basic pH may be helpful in some applications, for example to wash-out components that are soluble in basic solutions such as proteins and lipids, while leaving fibrous components of the matrix intact.

As described above, the disclosed processes for obtaining plant protein-enriched products (42, 44) have been optimized for use in food, inter alia because of the choice of solvents. Therefore, in an important additional aspect, presented herein are uses of the disclosed herein methods and their resulting plant protein-enriched products (42, 44) to obtain plant protein for consumption, notable for human food or animal feed.

The concept underlying the present disclosure has been described by reference to different embodiments as discussed above. It will be recognized that these embodiments are susceptible to various modifications and alternative forms well known to those of skilled in the art.

Furthermore, for a proper understanding of this document and its claims, it is to be understood that the verb ‘to comprise’ and its conjugations are used in its non-limiting sense to mean that items following the word are included, but items not specifically mentioned are not excluded. In addition, reference to an element by the indefinite article ‘a’ or ‘an’ does not exclude the possibility that more than one of the element is present, unless the context clearly requires that there be one and only one of the elements. The indefinite article ‘a’ or ‘an’ thus usually means ‘at least one’

### EXAMPLES

### Example 1—Process for Preparation of Rapeseed Protein Isolate Raptein™90

Two runs tagged as S-157 and S-159 were performed and the obtained samples of RPI (Rapeseed Protein Isolate) were compared for chemical purity and functionality. In the run yielding sample S-157 RPI, recovered azeotrope was used as the third solvent with composition of: ˜76% w/w ethyl acetate, <0.1% water, ethanol ad limitum.

In the run yielding sample S-159 RPI, ethyl acetate of technical purity (>96%) w/w was used as the third solvent.

Recovery of azeotrope was performed from spent solvents that were used in the production of protein isolate and protein-fibre product. Recovery was accomplished in a 20 L rotary evaporator (Heidolph) at the temperature of 40° C. and absolute pressure of 140 mbar. Main components of the spent solvent mixture used for recovery of azeotrope were: ethyl acetate, ethanol, water, lipids stemming from rapeseed, such as oil and phospholipids, and salts used in the process: NaCl, CaCl₂).

Starting material was supplied by rapeseed processing company. In the case of 5-159, the cake was a regular quality cold-pressed rapeseed cake (with seedcoats/hulls present) and in case of 5-157 the cake was cold-pressed rapeseed kernel devoid of seedcoats/hulls.

Composition of starting material for these two runs are given below (% w/w DW, except for moisture content):

| | S-159 | S-157 |
|---|---|---|
| Protein (N × 6.25 Kjeldahl) | 33.44% | 41.38% |
| Total Dietary Fibre (TDF) | 29.54% | 20.16% |
| Fat | 15.75% | 10.81% |
| Phytates | 2.95% | 4.95% |
| Ash | 6.56% | 7.32% |
| Moisture content | 5.31% | 4.68% |

Protocol for the process of obtaining Rapeseed Protein Isolate was similar for both samples S-159 and S-157 and is described below.

### Extraction Step

6 kg of Rapeseed Cake was suspended in extraction medium: 0.9% NaCl, 0.1% Na₂SO₃, 0.1% E211, 0.1% EtOH, water ad limitum. Extraction unit was 30 L ALSEOS device as described in WO2019011904, which is hereby incorporated by reference. Temperature was maintained at 15° C. and native pH=5.8. 2CV=ca 60 L of Crude Extract was collected after 4 hrs processing time with the flowrate to and out of the ALSEOS unit ca 15 L/h.

### Clarification Step

Collected Crude Extract was subjected to pH adjustment by 0.1 N NaOH to pH=6.8 and after 20 min incubation in a STR, the extract was subjected to Solid-Liquid Separation in a bucket centrifuge at 4000 G to recover Clarified Extract as a supernatant phase.

[NOTE: Extraction step in the ALSEOS device can be reproduced in a Stirred Tank Reactor by adding 6 kg of Rapeseed Cake to 80 L of Extraction medium and incubating the slurry at 15° C. for 4 hrs at native pH=5.8 under gentle agitation (Just-suspended conditions using anchor type or hydrofoil impeller), followed by pH adjustment to pH=6.8 and followed by solid-liquid separation step using suitable technique such as bucket centrifuge at 4000×G, to recover Clarified extract as a supernatant phase.]

### UF/DF Step

Clarified extract was then subjected to UF/DF step in a cross-flow membrane filtration unit using 10 kDa (Hollow fibre, GE, UFP-10-E-8A) using demineralized water as a dia-medium. Amount of diafiltration volume was ca 2 times original volume of the Clarified Extract. After reaching conductivity below 7 mS/cm, the retentate was concentrated to ca 5% dry solid content in the final retentate.

### Ethanolic Step

Concentrated UF Retentate from UF/DF step was subjected to treatment with ethanol (purity >92% w/w) in the run S-159 and ethanol (purity >96%) in the run S-157. The ratio of ethanol to UF Retentate was 1.9:1 (w/w) in both runs. Addition of ethanol was completed in 15 minutes under vigorous agitation in a STR vessel. Temperature was kept at 5° C. After additional 15 minutes incubation time, the mixture was subjected to solid-liquid separation step using bucket centrifuge at 4000×G for 20 minutes (min). Wet pellet was taken for further processing and the supernatant was discarded.

### Ethyl Acetate Wash Step

Wet pellet from ethanolic step was mixed with ethyl acetate solvent (Solvent 3) at the ratio (w/w) 5:1 Solvent 3:Wet pellet 5:1.

For sample (S-159), ethyl acetate of technical quality (>96% w/w) was used.

For sample (S-157), recovered azeotrope (76% (v/v) ethyl acetate, <0.1% water, ethanol ad limitum) was used.

Addition of 3^{rd} Solvent was completed under vigorous agitation in a STR device. After additional 15 min incubation time, the resulting mixture was subjected to solid-liquid separation in a bucket centrifuge at 4000×G for 20 min. The wet pellet was taken for further processing and the supernatant was discarded.

### Drying Step

Wet pellet obtained from the ethyl acetate wash step was subjected to drying procedure, comprising: drying of the cake to ca 1% moisture content in a vacuum tray chamber dryer at 400 mbar absolute pressure and 40° C., thereafter grinding/calibration of the cake to obtain PSD (Particle Size Distribution) between 40-150 microns and thereafter subjecting the calibrated powder to additional drying in a vacuum chamber at 50 mbars for 48 hrs at 40° C.

Same procedure was applied for sample S-157 and S-159

Samples obtained were analysed for chemical composition and functionality.

The results are given in a Table 1 below.

TABLE 1
EXAMPLE 1

| | | | Results | |
|---|---|---|---|---|
| | | | Rapeseed Protein Isolate | |
| Parameters | | | Raptein ™90 | |
| Batch no. | Target profile | Methods | S-157 RPI | S-159 RPI |
| Total protein | ≥90% DW | ISO 1871:2009 (N*6.25) | 92.8 | 97.7 |
| Soluble protein | ≥85% | Roe et al. (1990) | 86.88 | 87.92 |
| Moisture | ≤7.0% | PN-A-79011-8:1998, | 0.79 | 0.33 |
| | | 152/2010 | | |
| Carbohydrates* | ≤7.0% | — | 1.1 | 0.0 |
| Fat | ≤2.0% DW | PB/CH/16 (3th Ed.: | <0.10 | <0.20 |
| | | Sep. 11, 2028, 152/2009) | | |
| Ash | ≤4.0% DW | PN-A-79011-8:1998, | 1.57 | 0.33 |
| | | 152/2009 | | |
| Fibre | ≤0.5% DW | PN-A-79011-8:1998, | <0.30 | <0.15 |
| | | 152/2011 | | |
| Total | ≤1 mmol/kg | AOCS Ak 1-92, ISO 9167- | <0.05 | <0.05 |
| glucosinolates | | 1:1992/LC-UV/VIS | | |

Purity:

| | | | | |
|---|---|---|---|---|
| Total phytate | ≤1.5% DW | K-PHYT (Megazyme, | 0.78 | 0.22 |
| | | Ireland), enzymatic- | | |
| | | spectrophotometric method | | |
| Phenolics | % DW | HPLC/UV-VIS Ref: Siger, et. | 0.011 | 0.010 |
| | | al. (2004); Szydłowska- | | |
| | | Czerniak, et.al (2010) | | |

Functionality test:

| | | | | |
|---|---|---|---|---|
| Least Gelation | — | Khattab and Arntfield (2009) | 6% | 4% |
| Concentration | | with modifications | | |

*Calculated by difference: 100% - [protein % + moisture % + fat % + ash % + fibre %]

### Conclusion

Both samples of Rapeseed Protein Isolate are meeting the required profile for the critical quality attributes such as chemical purity and are comparable in terms of functional characteristics.

### Example 2—Process for Preparation of the Rapeseed Protein-Fibre Product Raptein™30

### Starting Material:

Pellet phase (wet cake) after solid-liquid separation step in the bucket centrifuge after Clarification step from the runs S-157 and S-159 was used to produce samples of Rapeseed Protein-fibre Product tagged as S-157 PFP and S-159 PFP respectively.

### Salt Wash Step

The pellet, containing ca 15-20% dry weight, was subjected to salt wash in a STR vessel at the conditions: pH=4 (adjusted with 0.1 HCl), temp ca 15° C., Medium 2% NaCl in water, Ratio 5:1 (w/w Medium:Pellet), incubation time 30 min under gentle agitation (just-suspended conditions). Thereafter, the mixture was subjected to solid-liquid separation step in the bucket centrifuge at 4000×G for 20 min. The pellet was taken for further processing and the supernatant was discarded.

### Alcoholic Wash Step

Pellet (wet cake) obtained from Salt wash step was mixed with ethanol of purity (70% v/v, 64% w/w) water ad limitum. Ratio 5:1 (w/w) ethanol:pellet.

Mixing in STR at gentle agitation (just-suspended conditions), 15 min incubation time, temp ca 15° C. Thereafter, the mixture was subjected to solid-liquid separation step in the bucket centrifuge at 4000×G for 20 min. The pellet was taken for further processing and the supernatant was discarded.

### 1^{st} Ethyl Acetate Wash Step

Pellet from Alcoholic wash step was mixed with 3^{rd} solvent. In case S-159 it was ethyl acetate (>96% w/w). In case S-157 it was recovered azeotropic mixture of ethyl acetate (76% v/v) and ethanol. Water content in this solvent mixture was <0.1%. Ratio: 5:1 (3^{rd} Solvent:Pellet).

Mixing in STR under vigorous agitation, 15 min incubation time, temp ca 15° C. Thereafter, the mixture was subjected to solid-liquid separation step in the bucket centrifuge at 4000×G for 20 min. The pellet was taken for further processing and the supernatant was discarded.

### 2^{nd} Ethyl Acetate Wash Step

Pellet from 1^{st} ethyl acetate wash step was mixed with 3^{rd} solvent. In case S-159 it was ethyl acetate (96% w/w). In case S-157 it was recovered azeotropic mixture of ethyl acetate (76% v/v) and ethanol. Water content in this solvent mixture was <0.1%. Ratio: 5:1 (3^{rd} Solvent:Pellet).

Mixing in STR under vigorous agitation, 15 min incubation time, temp ca 15° C. Thereafter, the mixture was subjected to solid-liquid separation step in the bucket centrifuge at 4000×G for 20 m. The pellet was taken for further processing and the supernatant was discarded.

### Drying Step

Wet pellet from 2^{nd} ethyl acetate wash step was placed in a vacuum chamber dryer at 40° C. and 400 mbar absolute pressure until moisture content reached <1% (w/w). Thereafter the material was ground/calibrated in a grinder to achieve PSD (Particle Size distribution) 40-150 microns. Thereafter the material was placed in a vacuum chamber dryer at 40° C. and 50 mbar absolute pressure for 24 hrs. Samples of protein-fibre products were analysed and compared for chemical composition and functionality.

The results are presented in Table 2.

TABLE 2
EXAMPLE 2

| | | | Results | |
|---|---|---|---|---|
| | | | Protein-Fibre Product | |
| Parameters | | | Raptein ™30 | |
| Batch no. | Target profile | Methods | S-157 PFP | S-159 PFP |
| Total protein | >30% DW | ISO 1871:2009 (N*6.25) | 45.0 | 47.1 |
| Moisture | ≤7.0% | PN-A-79011-8:1998, | 3.09 | 2.52 |
| | | 152/2010 | | |
| Total Dietary | >40% DW | AOAC Method 991.43 | 52.43 | 48.87 |
| Fibre (TDF) | | | | |
| Insoluble Dietary | >38% DW | AOAC Method 991.43 | 50.82 | 47.63 |
| Fibre (IDF) | | | | |
| Soluble Dietary | >1.5% DW | AOAC Method 991.43 | 1.61 | 1.24 |
| Fibre (SDF) | | | | |
| Fat | ≤2.0% DW | PB/CH/16 (3th Ed.: | <0.10 | 0.43 |
| | | Sep. 11, 2028, 152/2009) | | |
| Ash | ≤5.0% DW | PN-A-79011-8:1998, | 2.42 | 2.69 |
| | | 152/2009 | | |
| Fibre | >10% DW | PN-A-79011-8:1998, | 15.79 | 14.43 |
| | | 152/2011 | | |
| Total | ≤1 mmol/kg DW | AOCS Ak 1-92, ISO 9167- | <0.05 | <0.05 |
| glucosinolates | | 1:1992/LC-UV/VIS | | |

Purity:

| | | | | |
|---|---|---|---|---|
| Total phytate | ≤2% | K-PHYT (Megazyme, Ireland), | 1.2 | 1.0 |
| | | enzymatic-spectrophotometric | | |
| | | method | | |
| Phenolics | % DW | HPLC/UV-VIS Ref: Siger, et. | 0.018 | 0.025 |
| | | al. (2004); Szydłowska- | | |
| | | Czerniak, et.al (2010) | | |

Functionality test:

| | | | | |
|---|---|---|---|---|
| Water Absorption | — | water, pH of sample as is, | 6.2 g/g | 6.3 g/g |
| Capacity | | 1:10 (product:water) | | |
| WAC | | (4000 g, 30 min) | | |
| Oil Absorption | — | rapeseed oil, 1:10 | 2.5 g/g | 2.8 g/g |
| Capacity | | (product:oil) | | |
| OAC | | (4000 g, 30 min) | | |

### Conclusion

Both samples of Rapeseed Protein-Fibre Product are meeting the required target profile for the critical quality attributes such as chemical purity and are comparable in terms of functional characteristics.

### Example 3—Pilot Runs with Different Solvent Compositions Using Recovered Azeotropes for Generation of Rapeseed/Soybean Protein-Enriched Products and Assessment of Said Products' Critical Quality Attributes Such as Chemical Purity

### Objectives and Experimental Set-Up:

The main objective of the Pilot Runs was to further demonstrate that despite radical simplification of solvent composition and recovery, high-quality plant protein enriched products can be obtained, even from challenging plant material containing considerable amounts of oils, fats and/or lipids, such as from oilseeds, legumes or lentils.

To achieve this objective, we conducted experiments with 5 different solvent compositions needed for ethyl acetate (EA) wash step, all of which were used to obtain protein-fibre product, while 4 of which were used to obtain protein isolate product. The experiments were carried out in the same manner for two different raw materials, namely dehulled rapeseed cake (DRC) and soybeans (further referred to as to Rapeseed or Soybean Protein-enriched Products, respectively and where appropriate). Then, analytical data relating to chemical composition and/or functional properties was generated using Rapeseed/Soybean Protein-enriched Products as obtained according to the processes as described herein i.e. using recovered azeotropes instead of pure solvents.

### Recovery of Ethyl Acetate

Recovery of ethyl acetate was performed from spent solvents that were initially used in the protein isolate and protein-fibre concentrate production processes as disclosed in applications WO2019011904 and WO2020016222 of NapiFeryn BioTech Sp. z o.o., Poland. The recovery was performed in a 20 L rotary evaporator (Heidolph) at the temperature of 40° C. and absolute pressure of 140 mbar. Main components of the spent solvent mixture used for recovery of azeotrope were ethyl acetate, ethanol, water, lipids stemming from rapeseed, such as oil and phospholipids, and salts used in the process (e.g. NaCl). Average composition of the recovered solvent (i.e. light distillate from the 20 L Heidolph evaporator) is shown in Table 3 below.

TABLE 3
Average composition of the recovered solvent
(Solvent composition 2 in Table 4)

| Component | Content (% w/w) | Average deviation |
|---|---|---|
| Ethyl Acetate | 85.5 | 3.3 |
| Ethanol | 10.3 | 1.7 |
| Water | 4.2 | 1.0 |

### DETAILED PROCESS DESCRIPTION

Two main protein products: protein isolate and protein-fibre concentrate were obtained in process batches no. R-20, R-21.

Conducted experiments were aimed at replacing pure solvents with azeotropes in the EA (Ethyl Acetate) wash step. Different solvents compositions were shown in Table 4 below.

TABLE 4
Solvents' composition [ % w/w]

| Solvent | Ethyl | | | Other | |
|---|---|---|---|---|---|
| compositions | acetate | Ethanol | Water | impurities | Composition |
| Composition 1 | 100.00% | 0.00% | 0.00% | — | Pure solvent |
| Composition 2 | 85.50% | 10.30% | 4.20% | — | Solvent from SRP |
| Composition 3 | 70.00% | 22.00% | 8.00% | — | Pure solvents mixed |
| Composition 4 | 71.90% | 19.00% | 8.80% | 0.30% | Solvent from |
| | | | | | 600 L Pilot |
| | | | | | Evaporator* |
| Composition 5 | 52.20% | 33.34% | 13.40% | 1.06% | ML2 from protein |
| (R-20) | | | | | isolate line |
| Composition 5 | 58.21% | 28.06% | 13.60% | 0.13% | ML2 from protein |
| (R-21) | | | | | isolate line |

*600 L Pilot Evaporator operating in a range of absolute pressure 50 -200 mbar and temp 40° C.

The processes were carried out according to the process description below.

At the beginning of each process, the raw materials were prepared: full-fat soybean for R-20 and dehulled rapeseed cake (DRC) for R-21 were milled and sieved and the medium was prepared by dissolving salts in RO water. The solution contained sodium chloride, sodium sulphite, sodium benzoate and ethanol.

### 1) Soybean: R-20

The process started from extraction step, where the raw material R-20 was added and gently mixed with a dilute salt solution (medium). During this stage, the raw material suspension was obtained. Temperature of the slurry was controlled and maintained at the level of 6° C. Proteins' extraction from Soybean slurry lasted 24 h. The resulting RAE (Residue After Extraction) was centrifugated into 3 fractions: fat (discarded), CE1 (Crude Extract—processed to the isolate) and kernel (a starting material for the concentrate).

CE was passed through 1 m filters on the way to cross flow filtration system, for the UF/DF (ultra and diafiltration). During the first step of filtration, the pre-concentration took place, after which a diafiltration step was performed with three different diafiltration factors (acetate buffer, 0.9% NaCl, demi water). Thereafter, the final concentration took place. As a result, CE was concentrated almost 4 times, while its diafiltration factor was equal to 10, leading to UF Retentate with a solid content of ca. 10% (w/w) and conductivity of ca. 5 mS/cm generation.

The UF Retentate was then subjected to Ethanol Induced Precipitation (EIP). This process step used lower temperature of the retentate (<30° C.), after reaching which, a cooled ethanol solution (90% EtOH+10% H2O) was gradually added to the material while mixing, in order to precipitate the proteins. The volume of alcohol was determined by the amount of UF/DF concentrate and the set point of final concentration of 70% vol/vol=64% (w/w). The ethanol addition was carried out slowly in order to avoid denaturation of protein.

After mixing for approximately 25 min (dosing time included) the resulting ethanol suspension was fed into the centrifuge. After SLS step, there were two fractions: protein-rich residue (further processed) and the supernatant—Mother Liquor 1 (ML1) containing about 64% ethyl alcohol (later used for EtOH wash on the concentrates' line).

The solid residue from the EIP step was divided into four parts, and each one thereof was subsequently mixed with a different solvent: ranging from pure ethyl acetate or different azeotropes in accordance with the compositions as listed in the Table 4.

The solvent's volume was determined by the amount of the protein residue. The resulting suspension was then transferred to a centrifuge, where it was separated into a solid and liquid fraction. After SLS step the EAW (ethyl acetate wash) was repeated due to the material's characteristic relating to its high fat content. The resulting protein rich cake was transferred to the drying stage (described below) and the liquid fraction was stored for the solvent recovery procedure (SRP) or was used on the concentrates' line.

The protein fibre concentrates' production started when the Kernel was obtained from the Residue After Extraction (RAE). Afterwards, the Kernel went through 4 washing steps, employing ethanol (ML1) and pure ethyl acetate or the azeotropes as solvents. First washing step utilized ML1, which was mixed with kernel. The resulting suspension was then transferred to a centrifuge, where it was separated into a solid and liquid fraction. After that the EtOH Kernel was divided into 5 fractions, each one mixed with different solvent: pure ethyl acetate or azeotropes in accordance with the compositions as listed in Table 4. Next steps were conducted in the same manner as for EAW of isolate. After SLS step the EAW was repeated two times (3 EA washes in total) due to the material's characteristic. The second and third ethyl acetate wash was performed in order to remove the excess of lipids. The resulting protein-fibre rich cake was transferred to the drying stage and the liquid fraction was stored for the SRP.

### 2) Dehulled Rapeseed Cake (DRC): R-21

As for R-20, the process started from extraction step, when raw material R-21 was added and gently mixed with a dilute salt solution (medium). During this stage the raw material suspension was obtained. Temperature of the slurry was controlled and maintained at the level of 6° C.

The DRC slurry was pumped over to the ALSEOS unit (described in WO2016093698), to begin the process of extracting the Crude Extract from the slurry. During processing, the salt solution was constantly added to the ALSEOS unit and the Crude Extract was collected in stirred tank reactor. Proteins' extraction lasted 6 h.

Upon the extraction step (after more than 1CV=200 L of crude extract was collected), the RAE from the ALSEOS unit was fed to the centrifuge where the mixture was separated into two fractions—the water-based supernatant (CE2—pooled with the CE1) and the kernel (further processed to the concentrate).

Pooled Crude Extracts (CE1 & CE2) had their pH adjusted to the value of 6.8 with the addition of 0.5 M sodium hydroxide. The extract was heated to 45° C., then the pH adjustment to the value of 6.8 was repeated. In the next process step CE was clarified by passing through 5 m filters in a loop and after that 1 m filters on the way to cross flow filtration system, where it was directed for the UF/DF (ultra and diafiltration). During first step of filtration, the pre-concentration took place, after that there was a diafiltration with four different diafiltration factors (acetate buffer, 2% NaCl, 0.45% NaCl, demi water) and thereafter the final concentration took place. As a result CE was concentrated almost 4 times, while its diafiltration factor was equal to 42, leading to UF Retentate with a solid content of ca. 6% (w/w) and conductivity of ca. 4 mS/cm generation. This UF Retentate had its pH adjusted to the value of 6.8, and then it was centrifuged in order to remove the remaining phytates. The protein containing Retentate Supernatant was then subjected to the ethanol induced precipitation (EIP). This process step required lower temperature of the Retentate Supernatant (<30° C.), after reaching which, a cooled ethanol solution (90% EtOH+10% H2O) was added to the constantly mixed material in order to precipitate the proteins. The volume of alcohol was determined by the amount of UF/DF concentrate and the set point of final concentration of 70% vol/vol=64% (w/w). The ethanol addition was carried out slowly in order to avoid denaturation of protein.

After mixing for approximately 25 min (dosing time included) the resulting ethanol suspension was fed to the centrifuge. After SLS step, there were two fractions: protein-rich residue (further processed) and the supernatant—Mother Liquor 1 (ML1) containing about 64% ethyl alcohol (later used for EtOH wash on the concentrates' line).

The solid residue from the EIP step was divided into four parts, each one mixed with different solvent: pure ethyl acetate or azeotropes as shown in Table 4. The solvent's volume was determined by the amount of the protein residue. The output suspension was then transferred to a centrifuge, where it was separated into a solid and liquid fraction. The resulting protein rich cake was transferred to the drying stage (described below) and the liquid fraction was stored for the solvent recovery procedure (SRP) or was used on the concentrates' line.

The protein fibre concentrates' production started when the Kernel was obtained from RAE. Afterwards, kernel went through 5 washing steps, employing salts solutions, ethanol (ML1) and pure ethyl acetate or azeotropes as solvents. At the beginning, the Kernel was subjected to two salt wash steps. First one was conducted by mixing the Kernel with 2% NaCl, adjusting the pH value to 4.0 and separating the resulting suspension in a centrifuge, yielding two fractions: one with the Kernel and a supernatant. The supernatant was discarded and the Kernel was subjected to the second salt wash with 0.9% NaCl, pH=4.0. Next washing step utilized ML1, which was mixed with the Kernel. The resulting suspension was then transferred to a centrifuge, where it was separated into a solid and liquid fraction. After that the EtOH Kernel was divided into 5 fractions, each one mixed with different solvent: pure ethyl acetate or azeotropes (according to the Table 4). Next steps were conducted in the same manner as for EAW of isolate. After SLS step the EAW was repeated (2 EA washes in total). The second ethyl acetate wash was performed in order to remove the excess of lipids. The resulting protein-fibre rich cake was transferred to the drying stage and the liquid fraction was stored for the SRP.

### 3) Solids Handling: Drying, Milling, Calibration, Packaging (R-20, R-21)

RPI (protein isolate) and RPC (protein-fibre concentrate) were directed to three drying stages.

In the first drying step, the bulk of solvent was removed. After that the residual solvent was removed by use of humidified air. In the last stage the product was dried until it reached the setpoint of 93% DW.

First drying step was performed under vacuum in a tray vacuum dryer. Drying temperature was equal to 60° C., pressure was set to 140 mbar and the duration of this process was approximately 16-48 h depending on the material's amount. In the next step material was milled and sieved to ensure particle size below 150 μm.

Second drying step was designed to replace the residual solvent by water vapors by use of pre-humidified air as a drying medium. To facilitate that, the material was placed in vacuum tray-dryer equipped with a water bubbler. Swinging pressure from 640 to 140 mbar enabled semi-continuous flow of the air. Temperature was kept at 40° C., duration was typically 72 h.

In the final (third) drying step pressure was set to 800 mbar with rising temperature to 60° C. for 5 hours, after that pressure decreased to 40 mbar for 5 additional hours. Last two steps were designated to ensure humidity of material reach the setpoint of 5-7% w/w. Finished product was sampled for further analysis and packed in labelled Stand-up pouches (Doypacks).

The raw materials' characterisation is shown in Table 5 below.

TABLE 5
Raw materials

| Parameter | Unit | A-00#65 | A-00#63 |
|---|---|---|---|
| Type of material | — | Soybean, full-fat | DRC |
| | | | Dehulled Rapeseed |
| | | | Cake, Cold Pressed |
| Process ID | — | R-20 | R-21 |
| Protein | % DW | 40.35 ± 0.36 | 39.88 ± 0.38 |
| Fat Content | % DW | 20.94 ± 0.90 | 10.59 ± 0.73 |
| Dry Mass | % | 89.79 ± 0.50 | 94.33 ± 0.53 |

### Results

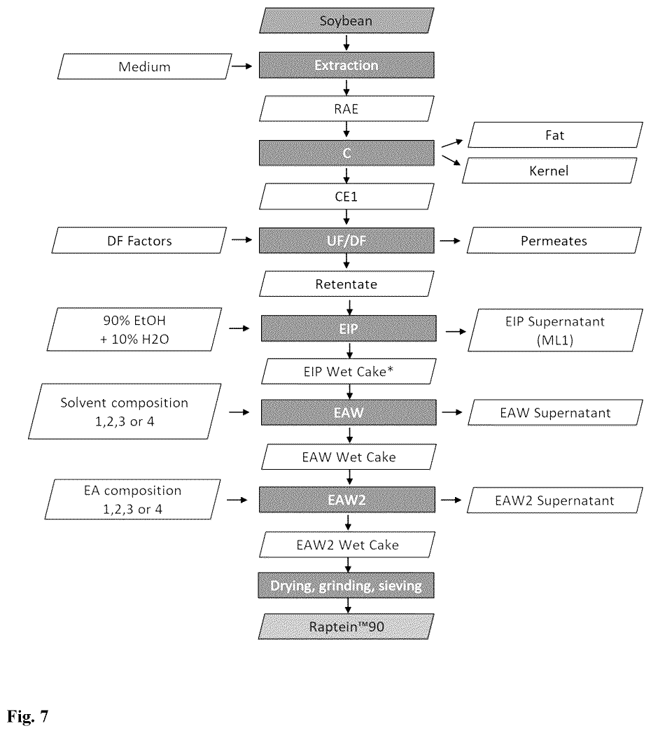

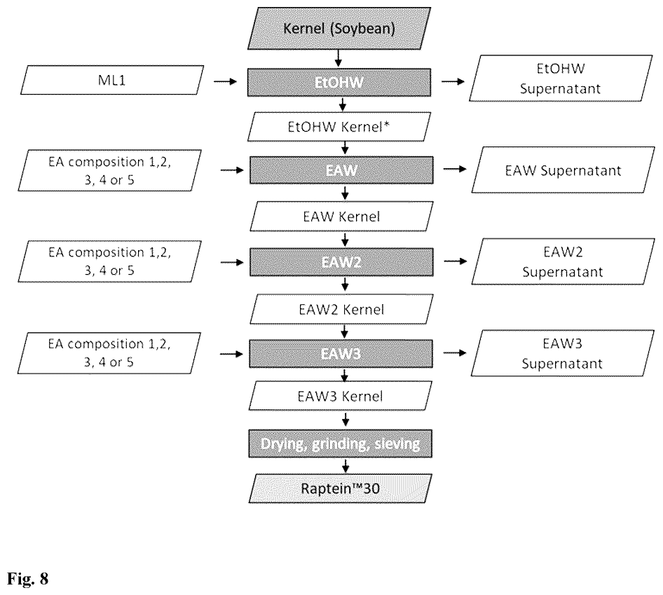

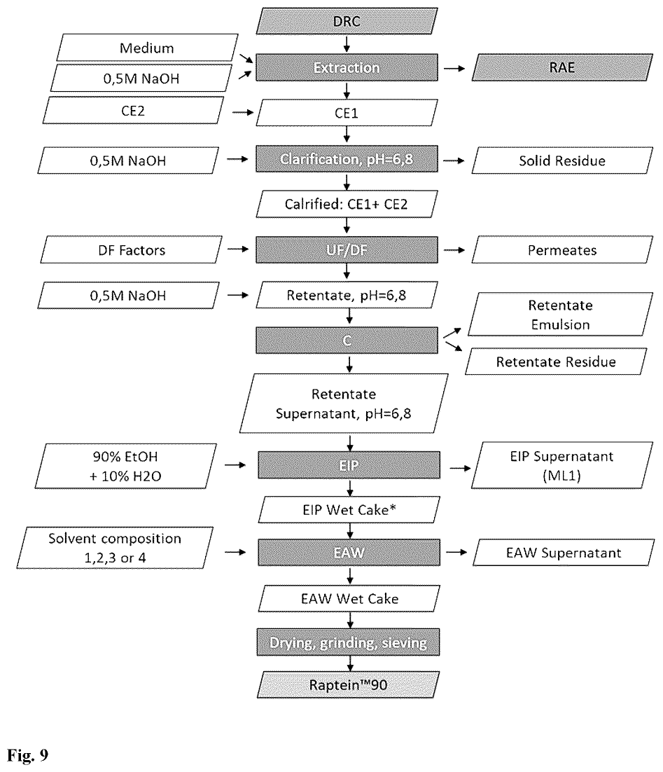

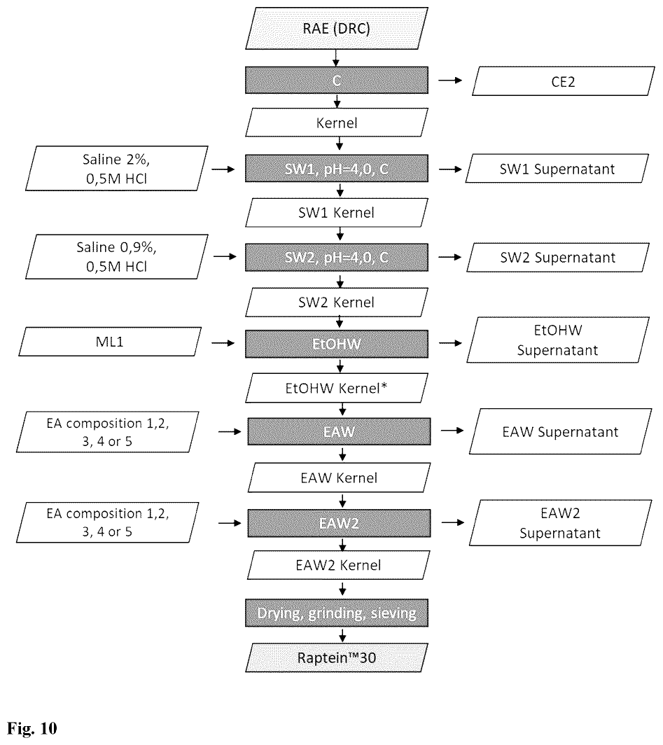

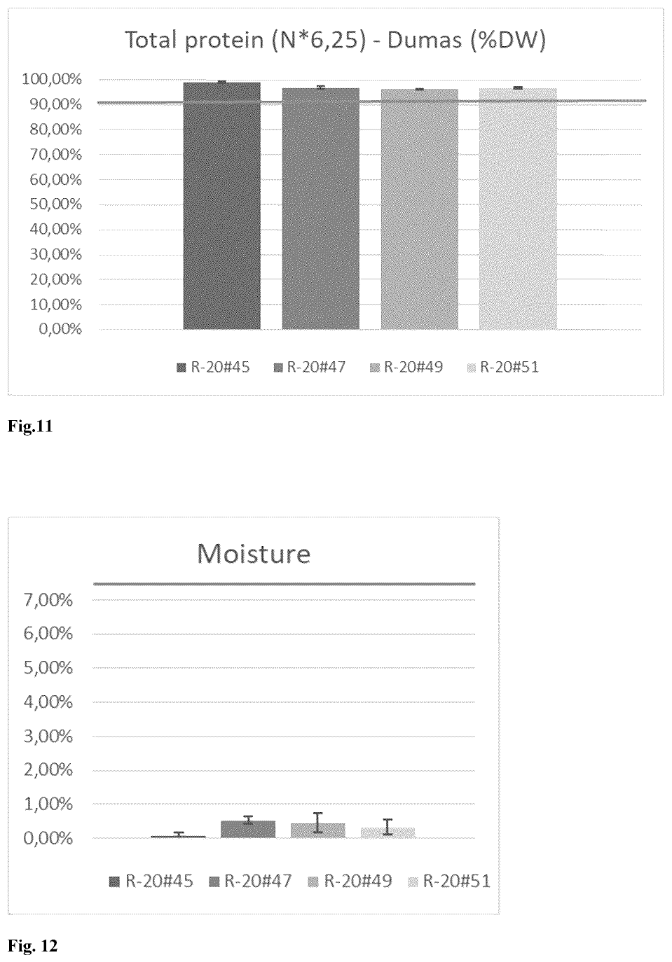

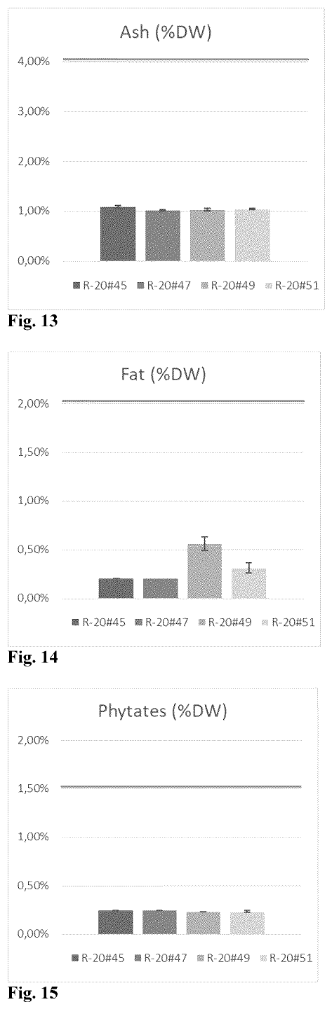

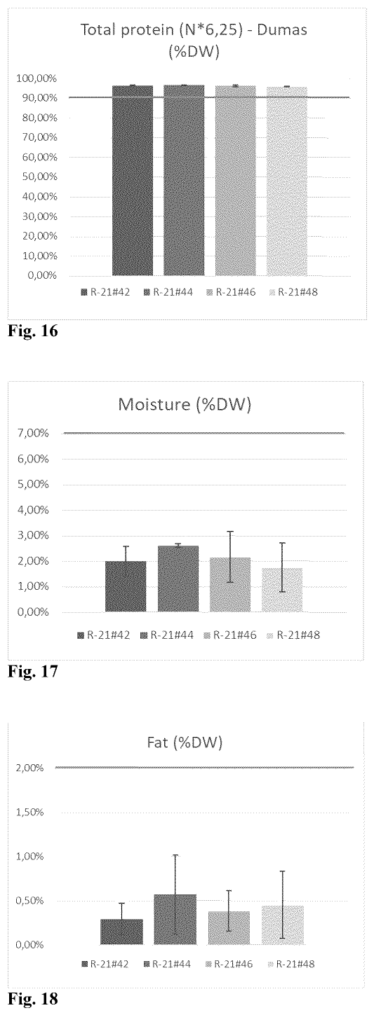

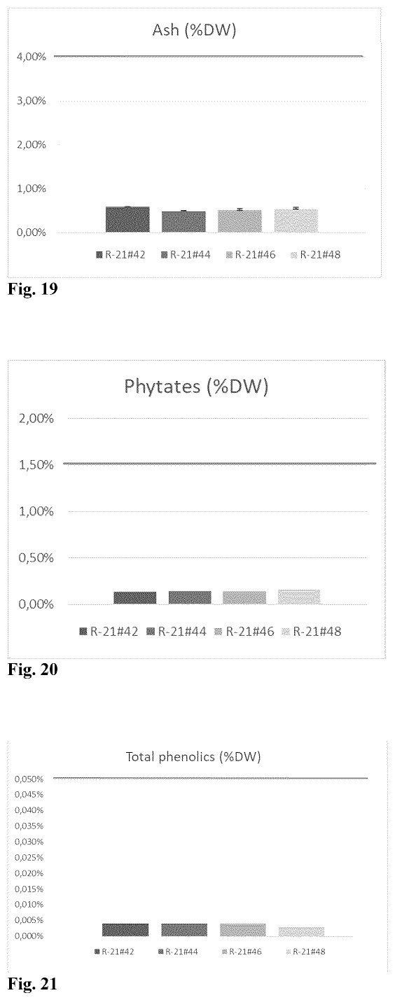

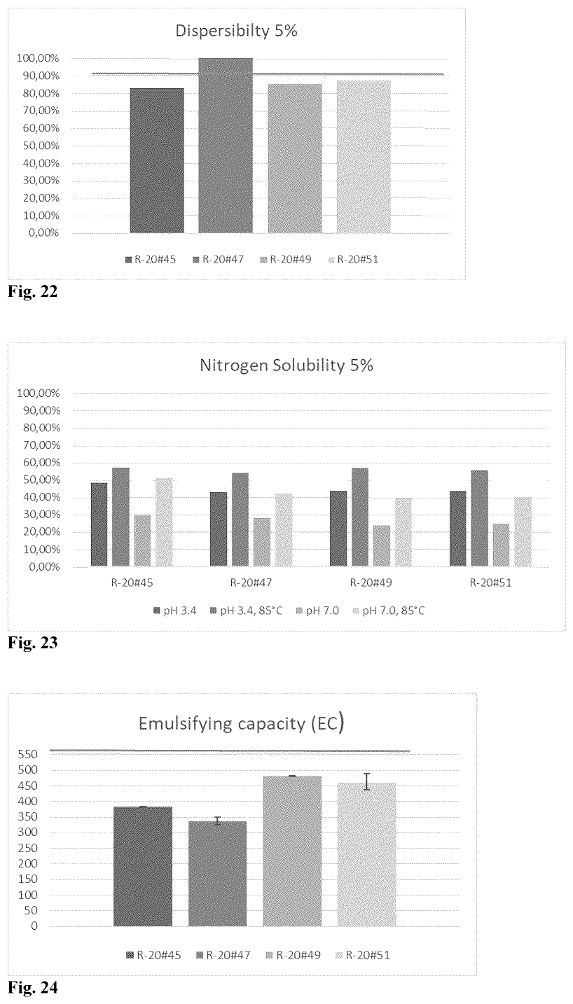

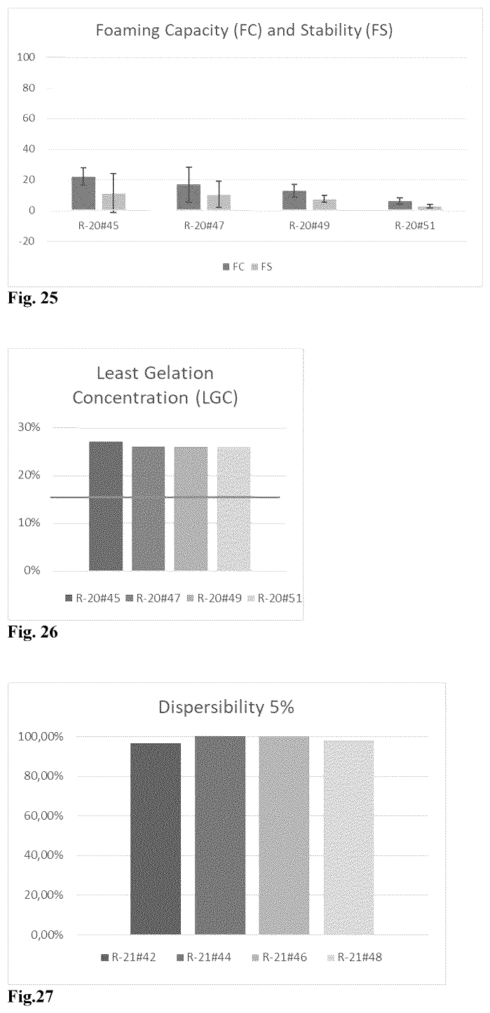

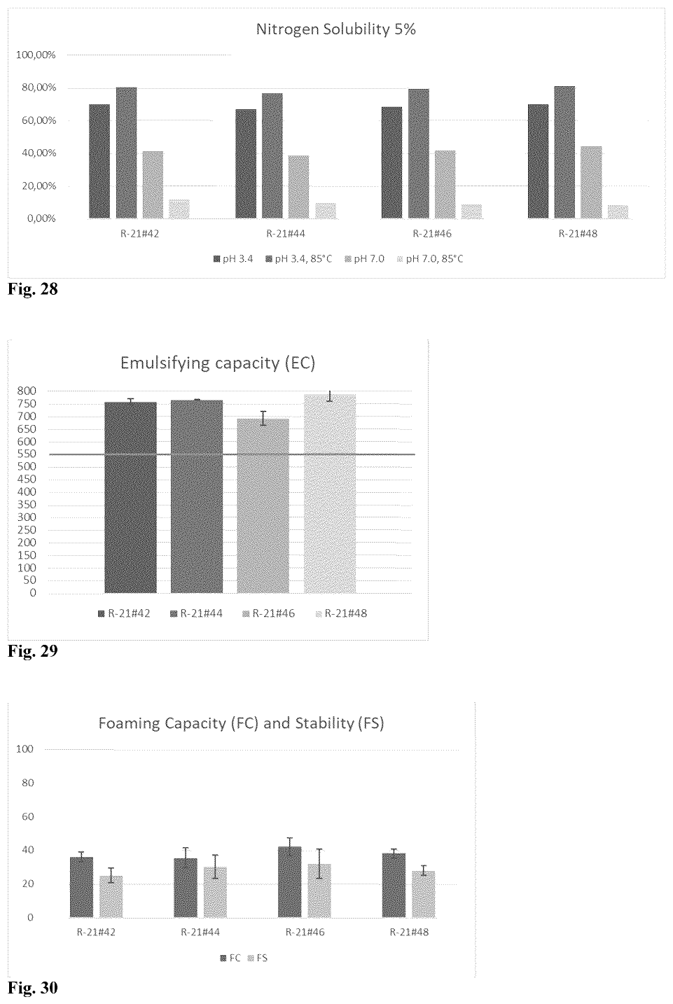

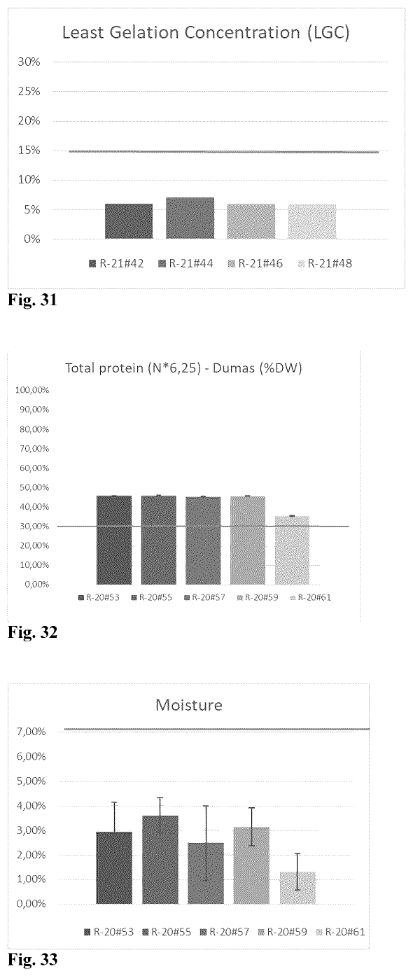

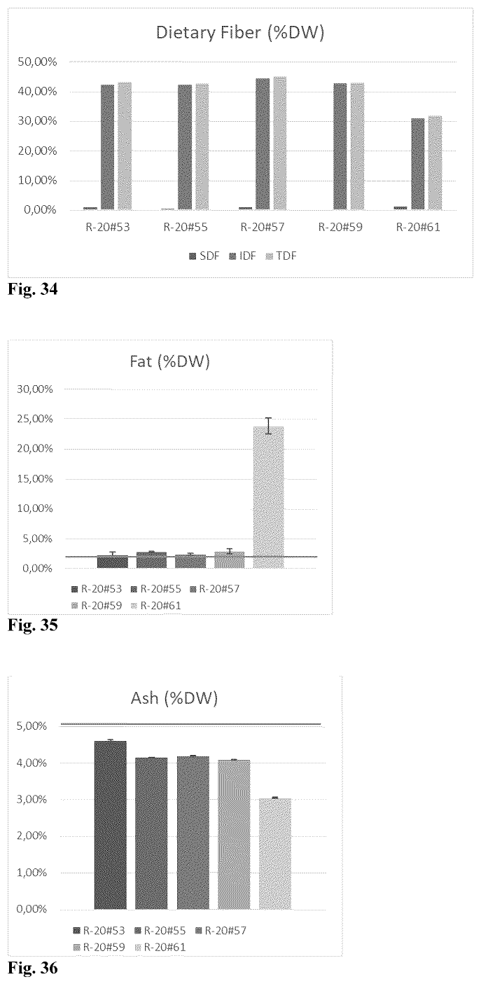

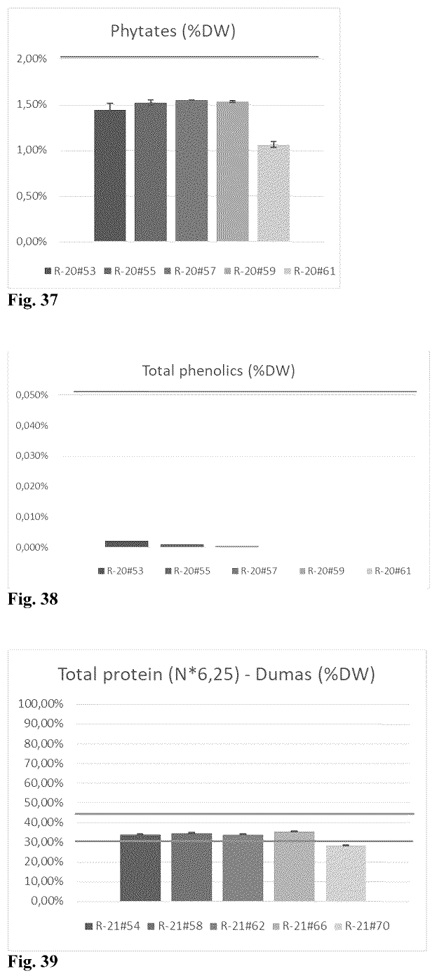

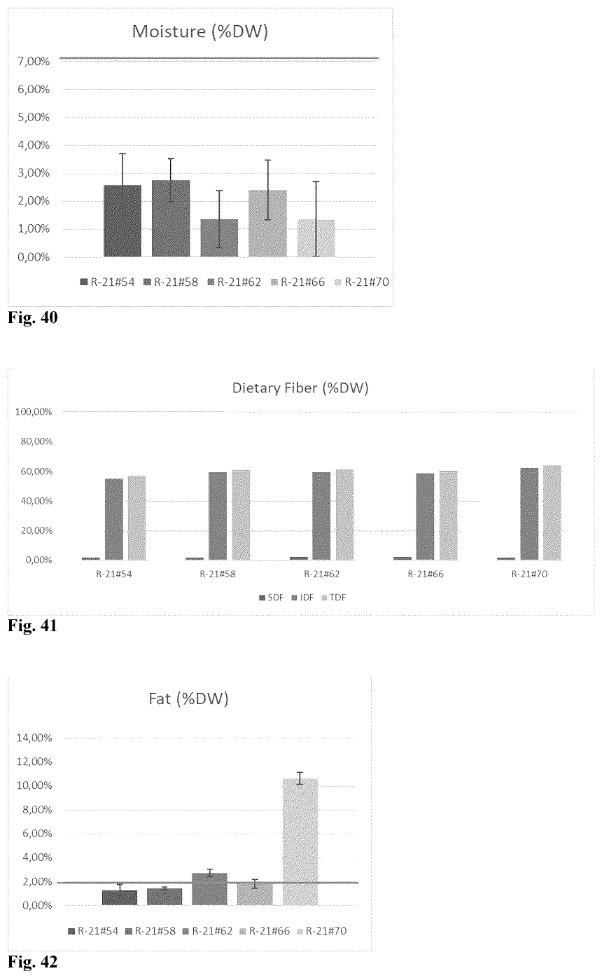

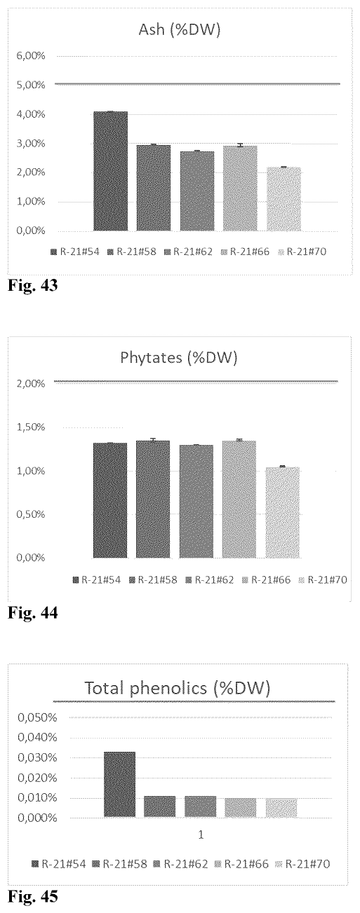

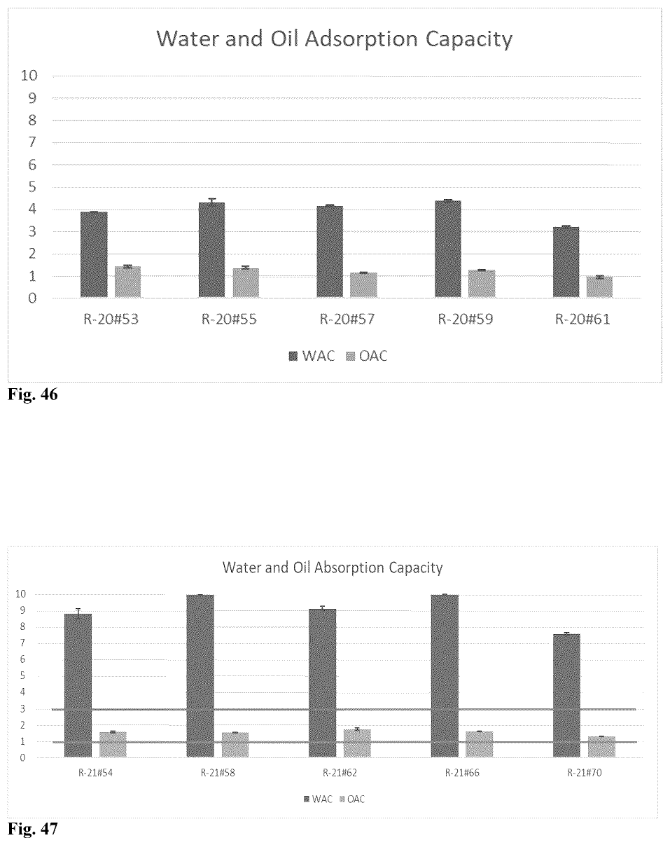

The results of the Pilot Runs are shown in Tables 6-12 and in FIGS. 7-46.

TABLE 6
Protein isolate products' results (Soybean)

| Parameter | R-20#45 | R-20#47 | R-20#49 | R-20#51 |
|---|---|---|---|---|
| Raw material | Soybean | Soybean | Soybean | Soybean |
| Solvent composition | 1 | 2 | 3 | 4 |
| Total protein [ % DM] | 98.86 ± 0.45 | 96.73 ± 0.5 | 96.17 ± 0.01 | 96.6 ± 0.36 |
| Moisture [%] | 0.06 ± 0.11 | 0.52 ± 0.11 | 0.45 ± 0.28 | 0.32 ± 0.23 |
| Fat [% DM] | 0.20 ± 0.00 | 0.20 ± 0.00 | 0.56 ± 0.07 | 0.31 ± 0.05 |
| Ash [% DM] | 1.08 ± 0.03 | 1.01 ± 0.01 | 1.03 ± 0.03 | 1.04 ± 0.01 |
| Total phytate [% DM] | 0.24 ± 0.00 | 0.24 ± 0.00 | 0.23 ± 0.00 | 0.23 ± 0.01 |
| Total phenolics [% DM] | 0.000 | 0.000 | 0.000 | 0.000 |
| Ethanol [mg/kg] | —* | —* | —* | —* |
| Ethyl acetate [mg/kg] | —* | —* | —* | —* |

*not measured

TABLE 7
Protein isolate products' results (DRC)

| Parameters | R-21#42 | R-21#44 | R-21#46 | R-21#48 |
|---|---|---|---|---|
| Raw material | DRC | DRC | DRC | DRC |
| Solvent composition | 1 | 2 | 3 | 4 |
| Total protein [% DM] | 96.13 ± 0.39 | 96.46 ± 0.05 | 96.04 ± 0.42 | 95.84 ± 0.12 |
| Moisture [%] | 1.98 ± 0.59 | 2.60 ± 0.08 | 2.15 ± 1.01 | 1.74 ± 0.96 |
| Fat [% DM] | 0.29 ± 0.18 | 0.57 ± 0.45 | 0.38 ± 0.23 | 0.45 ± 0.38 |
| Ash [% DM] | 0.58 ± 0.01 | 0.49 ± 0.01 | 0.52 ± 0.02 | 0.55 ± 0.02 |
| Total phytate [% DM] | 0.13 ± 0.0 | 0.14 ± 0.0 | 0.14 ± 0.0 | 0.16 ± 0.0 |
| Total phenolics [% DM] | 0.004 | 0.004 | 0.004 | 0.003 |
| Ethanol [mg/kg] | 220 ± 66 | —* | 202 ± 61 | —* |
| Ethyl acetate [mg/kg] | 579 ± 174 | —* | 359 ± 108 | —* |

*not measured

TABLE 8
Protein isolate Functional Properties

| Functionality Tests | Methods | R-20#45 | R-20#47 | R-20#49 | R-20#51 | R-21#42 | R-21#44 | R-21#46 | R-21#48 |
|---|---|---|---|---|---|---|---|---|---|
| Raw material | — | Soybean | Soybean | Soybean | Soybean | DRC | DRC | DRC | DRC |
| Solvent | — | 1 | 2 | 3 | 4 | 1 | 2 | 3 | 4 |
| composition | | | | | | | | | |
| Dispersibility | | 83.14 | 100.84 | 85.21 | 87.49 | 96.72 | 100.72 | 101.94 | 98.22 |
| [%] | | | | | | | | | |
| NS [%] | pH 3.4 | 48.49 | 43.09 | 43.66 | 43.92 | 69.94 | 66.78 | 68.33 | 69.96 |
| | pH 7.0 | 29.96 | 27.92 | 23.75 | 24.92 | 41.50 | 38.43 | 41.74 | 44.31 |
| Emulsification | water, pH | 383.4 ± | 336.0 ± | 481.6 ± | 462.3 ± | 757.1 ± | 765.4 ± | 691.0 ± | 787.5 ± |
| Capacity [g oil/ | of sample*, | 0.11 | 12.66 | 0.52 | 25.60 | 12.73 | 1.04 | 27.14 | 27.38 |
| g protein] | 1% (7200 rpm, | | | | | | | | |
| | 5 min) | | | | | | | | |
| Foaming | water, pH | 22.00 ± | 16.67 ± | 12.67 ± | 6.00 ± | 36.00 ± | 35.33 ± | 42.00 ± | 38.00 ± |
| Capacity [%] | of sample*, | 5.66 | 11.55 | 4.16 | 2.00 | 2.83 | 6.11 | 5.29 | 2.83 |
| | 1% | | | | | | | | |
| Foaming | water, pH | 11.01 ± | 10.33 ± | 7.33 ± | 2.67 ± | 25.00 ± | 30.00 ± | 32.00 ± | 28.00 ± |
| Stability [%] | of the | 12.73 | 8.39 | 2.31 | 1.15 | 4.24 | 6.93 | 8.72 | 2.83 |
| | sample*, 1% | | | | | | | | |
| Least Gelation | water, pH | 27 | 26 | 26 | 26 | 6 | 7 | 6 | 6 |
| Concentration | of sample* | | | | | | | | |
| [%] | | | | | | | | | |

*range 5.8-7.2

TABLE 9
Protein -fibre concentrate products' results (Soybean)

| Parameters | R-20#53 | R-20#55 | R-20#57 | R-20#59 | R-20#61 |
|---|---|---|---|---|---|
| Raw material | Soybean | Soybean | Soybean | Soybean | Soybean |
| Solvent composition | 1 | 2 | 3 | 4 | 5 |
| Total protein [% DM] | 45.70 ± 0.14 | 45.86 ± 0.15 | 45.35 ± 0.26 | 45.60 ± 0.22 | 35.18 ± 0.23 |
| Moisture [%] | 2.92 ± 1.22 | 3.60 ± 0.72 | 2.50 ± 1.49 | 3.13 ± 0.77 | 1.31 ± 0.75 |
| Total Dietary Fibre (TDF) | 43.30 | 42.71 | 45.15 | 43.06 | 31.97 |
| [% DM] | | | | | |
| Insoluble Dietary Fibre (IDF) | 42.32 | 42.30 | 44.32 | 42.74 | 30.84 |
| [% DM] | | | | | |
| Soluble Dietary Fibre (SDF) | 0.98 | 0.41 | 0.83 | 0.32 | 1.13 |
| [% DM] | | | | | |
| Fat [% DM] | 2.21 ± 0.52 | 2.78 ± 0.12 | 2.35 ± 0.21 | 2.86 ± 0.40 | 23.80 ± 1.38 |
| Ash [% DM] | 4.59 ± 0.04 | 4.14 ± 0.01 | 4.19 ± 0.02 | 4.09 ± 0.01 | 3.04 ± 0.02 |
| Total phytate [% DM] | 1.44 ± 0.07 | 1.52 ± 0.03 | 1.55 ± 0.00 | 1.53 ± 0.01 | 1.06 ± 0.03 |
| Total phenolics [% DM] | 0.002 | 0.001 | 0.000 | 0.000 | 0.000 |
| Ethanol [mg/kg] | —* | —* | —* | —* | —* |
| Ethyl acetate [mg/kg] | —* | —* | —* | —* | —* |

*not measured

TABLE 10
Protein -fibre concentrate products' results (DRC)

| Parameters | R-21#54 | R-21#58 | R-21#62 | R-21#66 | R-21#70 |
|---|---|---|---|---|---|
| Raw material | DRC | DRC | DRC | DRC | DRC |
| Solvent composition | 1 | 2 | 3 | 4 | 5 |
| Total protein [% DM] | 33.83 ± 0.16 | 34.59 ± 0.35 | 33.88 ± 0.30 | 35.35 ± 0.17 | 28.37 ± 0.16 |
| Moisture [%] | 2.57 ± 1.11 | 2.74 ± 0.78 | 1.34 ± 1.02 | 2.40 ± 1.07 | 1.35 ± 1.34 |
| Total Dietary Fibre (TDF) | 57.04 | 61.14 | 61.41 | 60.71 | 64.24 |
| [% DM] | | | | | |
| Insoluble Dietary Fibre (IDF) | 55.05 | 59.35 | 59.35 | 58.53 | 62.30 |
| [% DM] | | | | | |
| Soluble Dietary Fibre (SDF) | 1.99 | 1.79 | 2.06 | 2.18 | 1.94 |
| [% DM] | | | | | |
| Fat [% DM] | 1.28 ± 0.47 | 1.42 ± 0.09 | 2.71 ± 0.30 | 1.81 ± 0.37 | 10.62 ± 0.51 |
| Ash [% DM] | 4.08 ± 0.02 | 2.94 ± 0.01 | 2.73 ± 0.01 | 2.92 ± 0.05 | 2.18 ± 0.01 |
| Total phytate [% DM] | 1.32 ± 0.00 | 1.35 ± 0.02 | 1.30 ± 0.00 | 1.35 ± 0.01 | 1.05 ± 0.01 |
| Total phenolics [% DM] | 0.033 | 0.011 | 0.011 | 0.010 | 0.010 |
| Ethanol [mg/kg] | 12.4 ± 3.7 | —* | —* | 126 ± 38 | —* |
| Ethyl acetate [mg/kg] | 141 ± 42 | —* | —* | 50.8 ± 15.2 | —* |

*not measured

TABLE 11
Protein-fibre concentrate Functional Properties (Soybean)

| Functionality Tests | Method | R-20#53 | R-20#55 | R-20#57 | R-20#59 | R-20#61 |
|---|---|---|---|---|---|---|
| Raw material | — | Soybean | Soybean | Soybean | Soybean | Soybean |
| Solvent composition | — | 1 | 2 | 3 | 4 | 5 |
| Water Absorption | water, pH of | 3.86 ± 0.03 | 4.31 ± 0.15 | 4.15 ± 0.03 | 4.38 ± 0.06 | 3.19 ± 0.07 |
| Capacity [g water/g | sample*, 1:10 | | | | | |
| product] | (product:water) | | | | | |
| | (4000 g, 30 min) | | | | | |
| Oil Absorption | rapeseed oil, 1:10 | 1.43 ± 0.06 | 1.37 ± 0.05 | 1.16 ± 0.01 | 1.28 ± 0.01 | 0.95 ± 0.07 |
| Capacity [g oil/g | (product:oil) | | | | | |
| product] | (4000 g, 30 min) | | | | | |

*pH the range of sample: 3.8-4.2

TABLE 12
Protein-fibre concentrate Functional Properties (DRC)

| Functionality Tests | Method | R-21#54 | R-21#58 | R-21#62 | R-21#66 | R-21#70 |
|---|---|---|---|---|---|---|
| Raw material | — | DRC | DRC | DRC | DRC | DRC |
| Solvent composition | — | 1 | 2 | 3 | 4 | 5 |
| Water Absorption | water, pH of | 8.80 ± 0.29 | 9.95 ± 0.01 | 9.12 ± 0.13 | 9.97 ± 0.03 | 7.57 ± 0.09 |
| Capacity [g water/g | sample*, 1:10 | | | | | |
| product] | (product:water) | | | | | |
| | (4000 g, 30 min) | | | | | |
| Oil Absorption | rapeseed oil, 1:10 | 1.56 ± 0.07 | 1.53 ± 0.02 | 1.73 ± 0.06 | 1.61 ± 0.02 | 1.30 ± 0.02 |
| Capacity [g oil/g | (product:oil) | | | | | |
| product] | (4000 g, 30 min) | | | | | |

*pH the range of sample: 3.8-4.2

### Conclusions

The presented herein Pilot Runs with different solvent composition demonstrate efficient production of rapeseed/soybean protein-enriched products within advantageous quality attributes, using recovered azeotropes instead of pure solvents. The protein products were generated and analysed in terms of their composition and functionality. Based on the results, the following conclusions are made:
1. For each raw material (soybean, DRC) there were 7 products obtained with azeotropes and 2 with pure solvents, which were then compared within one product type (protein isolate or protein-fibre concentrate);
2. All samples of protein isolates (Soybean, DRC) met the desired requirements for the critical quality attributes such as chemical purity and were comparable in terms of functional characteristics.
3. Less pure solvents (azeotropes with ethyl acetate content above 70%) usage had no significant influence on products' measured chemical composition nor their functionality. Therefore, it can be concluded that, followed by additional research, the less pure solvents' usage is recommended for industrial scale production leading to the costs' reduction. Meeting these objectives can radically simplify solvent recovery process as compared to previously known methods, while at the same time providing similar high-quality plant protein enriched products.
4. Additionally, protein-fibre products washed with solvents with higher water content (composition 5) had lower level of ash, which is recognized as a positive aspect and may be correlated with salts' dissolving.

### Description of the Analytical Methods

### Dry Matter Content

A sample (2.0±0.5 g for raw plant material, 1.0±0.5 g for protein isolates/concentrates) was placed in a moisture analyzer at a temperature of 105° C. The moisture content was determined from the difference in the sample weight before and after drying.

### Protein Content

1) The protein content In Example 3 was determined according to the AOAC Official Method 992.23 (1992). The Dumas combustion method for determination of the total Nitrogen content in an organic matrix. The sample is combusted at high temperature in an oxygen atmosphere, nitrogen is quantitatively converted to N2 and converted into protein by using conversion factor (6,25).
2) The protein content in Example 1 and 2 was determined by the Kjeldahl method according to AOAC Official Method 2001.11 (2005). A conversion factor of 6.25 was used to determine the amount of protein (wt %).

### Ash Content

The ash content analysis (in raw material, protein isolates and concentrates) was done in accordance to the WE 152/2009. 1 g of sample was fumed gradually to 550° C. After that samples were incinerated in the oven in 600° C.

### Fat Content

The fat content was determined according to the Weibull-Stoldt Method. A sample (raw plant material and protein isolates/concentrates) was hydrolyzed with solution 10% (v/v) HCl and heated to 300° C. using an infrared heating system. The hydrolyzed sample was extracted with petroleum ether in the Extraction System.

The fat content (X) was calculated as wt % according to the formula:

$$X = \frac{( a - b )}{c} \times 100 \%$$

wherein:
a is the mass of the glass sample tube with the sample fat after drying (g);
b is the mass of the glass sample tube after drying (g); and
c is the mass of the sample (g).

### Phenolic Content

The analysis was performed according to Siger, et. al. (2004); Szydlowska-Czerniak, et. al (2010) with modifications. A defatted (<1% w/w fat) sample in a certain amount (0.50±0,005 g for rapeseed protein isolate or 0.25±0,005 g for rapeseed protein-fibre product) were extracted in a two-stage extraction with 70% (v/v) aqueous methanol solution containing 0.1% (v/v) acetic acid in an orbital shaker. First step of extraction was conducted for 1 hour at 450 rpm at room temperature. Then, the extract was purified from proteins with 10% (v/v) trichloroacetic acid (TCA). Afterwards, the second step of extraction was conducted for 0.5 hour at 450 rpm at room temperature. Supernatant 1 (from first stage extraction) and Supernatant 2 (from second stage of the extraction) were obtained after centrifuging for 10 min at 10 000×g. The supernatants were pooled and diluted to an end volume of 10 mL with 70% (v/v) aqueous methanol solution containing 0.1% (v/v) acetic acid, filtered through a PTFE syringe filter, with a pore size of 0.45 μl.

Polyphenol extract was analyzed by HPLC/UV-VIS using gradient conditions as described below

TABLE 13
Parameters of the chromatographic
separation of phenolic compounds

| | | 2.5% acetic acid in |
|---|---|---|
| Time [min] | 100% methanol | distilled water |
| 0 | 0 | 100 |
| 10 | 10 | 90 |
| 18 | 20 | 80 |
| 40 | 70 | 30 |
| 41 | 0 | 100 |
| 50 | 0 | 100 |

Phase phase flow: 1 ml/min
Wavelength: λ=320 nm
Injection: 50 μl
Column: Bionacom Velocity C18 (150 mm×4.6 mm, 5 μm)

### Phytate Content

The phytate content analysis (in raw material, protein isolates and concentrates) was done in accordance to the phytic acid (phytate)/total phosphorus assay procedure K-PHYTY 08/14 by Phytic Acid (Total Phosphorous) Assay Kit Megazyme.

### Total Fibre

The content of total fibre (in raw material and protein concentrates) was determined according to the AOAC Official Method 30 991.43, Total, soluble, and insoluble dietary fibre in foods, Enzymatic-gravimetric method, MES-TRIS buffer, USA, 1994.

### Methods for Functionality Testing for Protein Isolates

### Dispersibility

The assessment was performed according to the following steps: Weigh protein isolate (final protein concentration 5% w/v) to 150 ml beaker. Add 10 ml of deionized water. Stir 1 hour with the use of magnetic stirrer at approximately 500 rpm. Determine the dispersed protein content using the Dumas method (200 μl in 3 replicates).

Calculate dispersibility with formula:

$$Dispersibility ( \% ) = \frac{dispersed protein concentration ( \% )}{protein concentration in the solution ( \% )} wherein :$$

$$Protein concentration in the solution means :$$

$$\frac{\begin{matrix}mass of the sample \times protein concentration \\ in sample ( Dumas method )\end{matrix}}{( mass of the beaker gross - mass of the beaker net ) \times 100}$$

### Nitrogen Solubility (NS):

The assessment was performed according to the following steps: Weigh protein isolate (final protein concentration: 5% w/w) to 150 ml beaker in duplicate. Add 10 ml of tested solvent to each beaker. Stir samples until powder is fully dispersed. Adjust pH to desired value (0.1 M NaOH and 0.1 M HCl). Allow to stir for 1 h at room temperature. At the end of that time, pipette a 200 μL aliquot (directly from the beaker) to determine the protein concentration using the Dumas method. Then, transfer 1 mL from the beaker to microcentrifuge tubes in six repetitions and centrifuge three of them for 10 min at 13,000 rpm. Carefully remove from centrifuge and pipette 200 μL aliquot of supernatant to determine protein content (Dumas method). Place the remaining 3 repetitions in a water bath (85° C.) for 30 min. Remove samples from the water bath and let rest for 5 minutes. Centrifuge the samples for 10 min at 13,000 rpm. Carefully remove from centrifuge and pipette 200 μL aliquot of supernatant to determine protein content (Dumas method).

Nitrogen solubility is calculated according to the formula:

$$\frac{protein content after centrifugation}{protein content before centrifugation} \times 100 = \% protein solubility$$

### Emulsifying Capacity (EC):

The assessment was performed according to the following steps: Weigh protein isolate (final protein concentration: 1% w/w) to 50 ml centrifuge tube. Add water to obtain 25 g of examined solution. Mix by vortex for 10 s. Stir at 450 rpm for 1 h at room temperature. Transfer obtained solution to the beaker and measure its conductivity. Homogenize with rapeseed oil for 5 min at 7200 rpm and measure conductivity of obtained emulsion. Add oil gradually while homogenizing until the conductivity of the emulsion drops abruptly and inversion of the emulsion is observed. Emulsion capacity is expressed as grams of oils homogenized per gram of protein.

Emulsifying capacity (EC) was analyzed according to the Karaca A. C. et al., Food Research International; Emulsifying properties of chickpea, faba bean, lentil and pea proteins produced by isoelectric precipitation and salt extraction, 2011, 44, 2742-2750 with modifications: in a beaker: 25 g 1% solution was used.

### Foaming Capacity (FC) and Foam Stability (FS)

The assessment was performed according to the following steps: Weigh protein isolate (final protein concentration: 1%) to a beaker and add 99 ml of deionized water. Stir on a magnetic stirrer for 5 min. Homogenize for 1 min at 10000 rpm. Transfer obtained foam to graduated cylinder and read foam volume. Read the volume after 5 min, 15 min, 30 min, 60 min and 120 min.

$$FC ( \% ) = \frac{{V}_{1} - {V}_{0}}{{V}_{0}} \cdot 100$$

$$FS ( \% ) = \frac{{V}_{2} - {V}_{0}}{{V}_{0}} \cdot 100$$

V₁=volume after whipping
V₀=volume before whipping
V₂=volume after standing (5, 15, 30, 60 and 120 min

Foaming capacity (FC) and foam stability (FS) was analyzed according to the Khattab R. Y., Arntfield S. D.; Functional properties of raw and processed canola meal; LWT—Food Science and Technology 42 (2009) 1119-1124 with modifications: 1% solution was made.

### Least Gelation Concentration (LGC)

The assessment was performed according to the following steps: Weigh the appropriate amount of sample to obtain desired concentration to the centrifuge tube. Add 30 ml of deionized water. Vortex for several seconds. Place samples to ultrasonic cleaning for 10 min. Stir for 20 min at 450 rpm. Transfer 20 ml of obtained solution to the centrifuge tube. Heat the sample in a water bath for 1 h at 80° C. Cool for 10 min in a cold water bath. After that cool for 2 h at 4° C. Place the centrifuge tube upside down for 1 min and check if the sample is gelated. Find the least gelation concentration by testing different concentrations (at 1 percentage point intervals) according to instruction above.

Gelation was investigated according by Khattab R. Y., Arntfield S. D.; Functional properties of raw and processed canola meal; LWT—Food Science and Technology 42 (2009) 1119-1124 with modifications: 20 ml was transferred to the new tube.

### Methods for Functionality Testing for Protein Concentrates

### Water and Oil Absorption Capacity (WAC and OAC)

The assessment was performed according to the following steps: Weigh 1 g of protein concentrate to 50 ml centrifuge tubes in triplicate. Add 10 g of deionized water or rapeseed oil and shake a few times in order to distribute the sample. Stir for 1 min at 450 rpm. Centrifuge for 30 min at 4000 g at 22° C. Gently decant obtained supernatant. Place centrifuge tubes upside down for 10 min to enable the rest of the supernatant to flow down. Weigh centrifuge tubes with wet sediment.

$$WAC ( OAC ) ( \frac{g}{g} ) = \frac{E - A}{B} - 1$$

A—weight of empty centrifuge tube
B—weight of examined sample
E—weight of centrifuge tube with wet sediment

### LITERATURE CITED

J. P. D. Wanasundara et al., Oilseeds and fats, Crops and Lipids, 2016, 23(4), D407
J. P. D. Wanasundara, Critical Reviews in Food Science and Nutrition, 2011, 51(7), 635-677
L. Campbell et al., Canola/Rapeseed Protein: Future Opportunities and Directions-Workshop Proceedings of IRC 2015, Plants 2016, 5, 17
Manashi Das Purkayastha et al., 2013, J. Agric. Food Chem., 2013, 61, 10746-10756; dx.doi.org/10.1021/jf403657c|
Manashi Das Purkayastha et al., 2014, J. Agric. Food Chem., 2014, 62, 7903-7914 dx.doi.org/10.1021/jf5023803|
G. L. Miller, Analytical Chemistry, 1959, 31, pp 426-428, 10
V. A. McKie and B. V. McCleary, Journal of AOAC International, 2016, 99(3), 738-743.
J. Vioque et al., Journal of the American Oil Chemists' Society, 2000, 77(4), 447-450
M. Garcia-Vaquero et al., Food Research International, 2017, 99(3), 971-978
A. Siger et al., Rośliny Oleiste—Oilseed Crops, 2004, XXV (1), 263-274

1. A process for preparation of a plant protein-enriched product from plant material, wherein said plant material comprises between 10 and 50 wt % on dry weight basis of proteins, said process comprising the steps of:
a) crushing or comminuting the plant material to produce a solid cake;
b) extracting the solid cake with an aqueous first solvent comprising at least 90 wt % of water, based on the total weight of the first solvent, to obtain a mixture of a first solid fraction and a first liquid fraction;
c) separating the first liquid fraction from the first solid fraction;
d) adding an alcoholic second solvent comprising at least 50 wt % of an alcohol having 1 to 5 carbon atoms which is miscible with water at room temperature, based on the total weight of the second solvent, wherein
the adding comprises adding the second solvent to the first solid fraction), or wherein
the adding of the second solvent is preceded by concentrating the first liquid fraction to obtain a first liquid fraction protein concentrate and wherein the adding comprises adding the second solvent to said concentrate;
e) separating any one of the mixtures obtained by adding the second solvent in step d) into a second liquid fraction and a second solid fraction;
f) adding a third solvent to the second solid fraction obtained in step e), said third solvent comprising an apolar and lipophilic organic ester having up to 5 carbon atoms wherein the apolar and lipophilic organic ester is at least partially miscible with the first solvent and fully miscible with the second solvent at room temperature, and wherein the amount of the third solvent is chosen such that the overall liquid phase does not separate into distinct liquid phases
g) separating the mixture obtained in step f) into a third liquid fraction, further referred to as spent third solvent and a third solid fraction;
h) drying the third solid fraction obtained in step g) to obtain the plant protein-enriched product,
the process characterised in that the third solvent comprises an azeotropic mixture comprising, based on the total weight of the third solvent:
between 64 to 90 wt % of the organic ester,
between 10 to 35 wt % of the alcohol having 1 to 5 carbon atoms, and
less than 10 wt % water.

2. The process according to claim 1, wherein the amount of the plant protein-enriched product obtained in the process amounts to at least 1 kg, preferably at least 5 kg, more preferably at least 10 kg, more preferably at least 20 kg, most preferably more than 100 kg per batch in a batchwise production process or as produced per hour in a continuous production process.

3. The process according to claim 1, wherein the amount of the solid cake extracted in the process amounts to at least 10 kg per batch in a batchwise production process or as extracted per hour in a continuous production process.

4. The process according to claim 1, wherein the azeotropic mixture comprises between 65 to 85 wt % of the organic ester, expressed as the mass fraction of the organic ester in the azeotropic mixture.

5. The process according to claim 1 4, wherein the organic ester is ethyl acetate.

6. The process according to claim 1, wherein the azeotropic mixture comprises between 12 to 32 wt %, of the alcohol having 1 to 5 carbon atoms, expressed as the mass fraction of the alcohol having 1 to 5 carbon atoms in the azeotropic mixture.

7. The process according to claim 1, wherein the alcohol having 1 to 5 carbon atoms is selected from the group consisting of methanol, ethanol, propanol, iso-propanol, butanol, iso-butanol, or combinations thereof, and wherein the alcohol having 1 to 5 carbon atoms preferably is ethanol.

8. The process according to claim 1, wherein the azeotropic mixture comprises ethyl acetate and ethanol, preferably comprises between 64 to 90 wt % of ethyl acetate and between 10 to 35 wt % of ethanol, based on the total weight of the third solvent.

9. The process according to claim 1, wherein the third solvent comprises less than 7 wt % water.

10. The process according to claim 1, wherein the drying in step h) of the third solid fraction generates a further portion of a spent third solvent.

11. The process according to claim 1, wherein at least a part of the third solvent added in step f) is recovered from any one of the following: the spent third solvent, the further portion of the spent third solvent, or a combination thereof.

12. The process according to claim 11, wherein the any one of the following: the spent third solvent, the further portion of the spent third solvent, or the a combination thereof, from which the part of the third solvent added in step f) is recovered, comprises at least 10 wt % water.

13. The process according to claim 11, wherein the recovering of the third solvent comprises application of an operating pressure being equal or lower than 200 kPa.

14. The process according to claim 11, wherein the recovering of the third solvent comprises an evaporation step comprising an evaporator, preferably chosen from the group comprising rotary evaporators, wiped-film evaporators, scraped-film evaporators, falling-film evaporators, rising-film evaporators, short-path evaporators, preferably being a falling-film evaporator.

15. The process according to claim 1, which is performed without using organic or mineral solvents having 6 or more carbon atoms, such as hexane.

16. The process according to claim 1, wherein the plant material is selected from the group consisting of oilseeds, including rapeseed, canola, sunflower, safflower, and cottonseed, pulses, including soybeans and other beans, legumes and peas, including chickpea, red, green, yellow and brown lentils, and combinations thereof.

17. The process according to claim 1, wherein the adding in step d) comprises adding the second solvent to the first solid fraction and wherein the plant protein-enriched product obtained in step h) is a protein-fibre product comprising plant protein and indigenous fibre.

18. The process according to claim 1, wherein
the plant protein-enriched product obtained in step h) is a protein isolate wherein the protein content is at least 90 wt % based on total dry weight of the protein isolate; and wherein
the adding in step d) is preceded by concentrating the first liquid fraction to obtain a first liquid fraction protein concentrate, said concentrate, and wherein the adding comprises adding the second solvent comprising at least 90 wt % of the alcohol to said concentrate; and wherein
preferably also wherein the third solvent added in step f) preferably comprises less than 2 wt % water, more preferably less than 1 wt % water, and most preferably less than 0.5 wt % water, and preferably also wherein
the protein content of the second solid fraction (22) obtained in step e) is at least 60 wt %, based on total dry weight of the second solid fraction (22); and/or
the protein content of the third solid fraction (32) obtained in step g) is at least 90 wt %, based on total dry weight of the third solid fraction (32).

19. The process according to claim 18, wherein the protein isolate comprises at least 70 wt % of native plant-based protein based on dry matter.

20. (canceled)
